(19) United States
(12) Patent Application Publication
(10) Pub. No.: US 2025/0189009 A1
(43) Pub. Date: Jun. 12, 2025

(54) SHOCK ABSORBER

(71) Applicant: Hitachi Astemo, Ltd., Ibaraki (JP)

(72) Inventor: Takamasa KOTANI, Hitachinaka-shi (JP)

(21) Appl. No.: 18/845,194

(22) PCT Filed: Mar. 17, 2023
(86) PCT No.: PCT/JP2023/010623

§ 371 Date: Sep. 9, 2024

(30) Foreign Application Priority Data
May 30, 2022 (JP) 2022-087331

(51) Int. Cl. F16F 9/34; F16F 9/32

(52) U.S. Cl. CPC F16F 9/34; F16F 9/3214

(57) ABSTRACT

The present shock absorber includes a cylinder, a piston, a piston rod, a first passage, a second passage, a first damping force mechanism, and a second damping force mechanism. The second damping force mechanism is provided at the second passage, includes a partition member which partitions the second passage, is displaced by a working fluid that has flowed in due to movement of the piston, and discharges at least some of the working fluid in the second passage into a cylinder, and a valve closing part which forms a pressure chamber closed between an inside of the second passage and the partition member to restrict movement of the working fluid in the pressure chamber, and varies a damping force.

### TECHNICAL FIELD

The present invention relates to a shock absorber.

Priority is claimed on Japanese Patent Application No. 2022-087331 filed on May 30, 2022, the content of which is incorporated herein by reference.

### BACKGROUND ART

There is a shock absorber having a partition member that partitions a passage and whose damping force characteristics are variable according to a vibration state (see, for example, Patent Document 1).

### CITATION LIST

### Patent Document

Patent Document 1: Japanese Patent No. 6722683

### SUMMARY OF INVENTION

### Technical Problem

Incidentally, it is desired to enhance durability of a partition member in a shock absorber.

Therefore, an objective of the present invention is to provide a shock absorber capable of enhancing durability of a partition member.

### Solution to Problem

In order to achieve the above-described objective, a shock absorber according to one aspect of the present invention includes a cylinder in which a working fluid is sealed, a piston fitted in the cylinder to be slidable and partitioning an inside of the cylinder into two chambers, a piston rod connected to the piston and extending to an outside of the cylinder, a first passage allowing communication between the two chambers so that the working fluid is able to flow due to movement of the piston, a second passage formed in parallel with the first passage and provided to allow the working fluid of at least one of the two chambers to flow in due to movement of the piston, a first damping force mechanism provided at the first passage and configured to generate a damping force, and a second damping force mechanism provided at the second passage, including a partition member which partitions the second passage, is displaced by the working fluid that has flowed in due to movement of the piston, and discharges at least some of the working fluid in the second passage into the cylinder, and a valve closing part which forms a pressure chamber closed between an inside of the second passage and the partition member to restrict movement of the working fluid in the pressure chamber, and varying a damping force.

### Advantageous Effects of Invention

According to the shock absorber of the above-described aspect of the present invention, durability of the partition member can be enhanced.

### BRIEF DESCRIPTION OF DRAWINGS

FIG. 1 is a cross-sectional view showing a shock absorber of a first embodiment of the present invention.

FIG. 2 is a cross-sectional view showing a main part of the shock absorber of the first embodiment.

FIG. 3 is a one-sided cross-sectional view showing a main part of a frequency sensitive mechanism of the shock absorber of the first embodiment.

FIG. 4 is a one-sided cross-sectional view showing a main part of the frequency sensitive mechanism of the shock absorber of the first embodiment.

FIG. 5 is a one-sided cross-sectional view showing a main part of a frequency sensitive mechanism of a shock absorber of a second embodiment of the present invention.

FIG. 6 is a one-sided cross-sectional view showing a main part of a frequency sensitive mechanism of a shock absorber of a third embodiment of the present invention.

FIG. 7 is a one-sided cross-sectional view showing a main part of a frequency sensitive mechanism of a shock absorber of a fourth embodiment of the present invention.

FIG. 8 is a one-sided cross-sectional view showing a main part of a frequency sensitive mechanism of a shock absorber of a fifth embodiment of the present invention.

FIG. 9 is a cross-sectional view showing a main part of a shock absorber of a sixth embodiment.

FIG. 10 is a cross-sectional view showing a main part of a shock absorber of a seventh embodiment of the present invention.

FIG. 11 is a one-sided cross-sectional view showing a main part of a frequency sensitive mechanism of a shock absorber of an eighth embodiment of the present invention.

FIG. 12 is a cross-sectional view showing a main part of a shock absorber of a ninth embodiment of the present invention.

### DESCRIPTION OF EMBODIMENTS

### First Embodiment

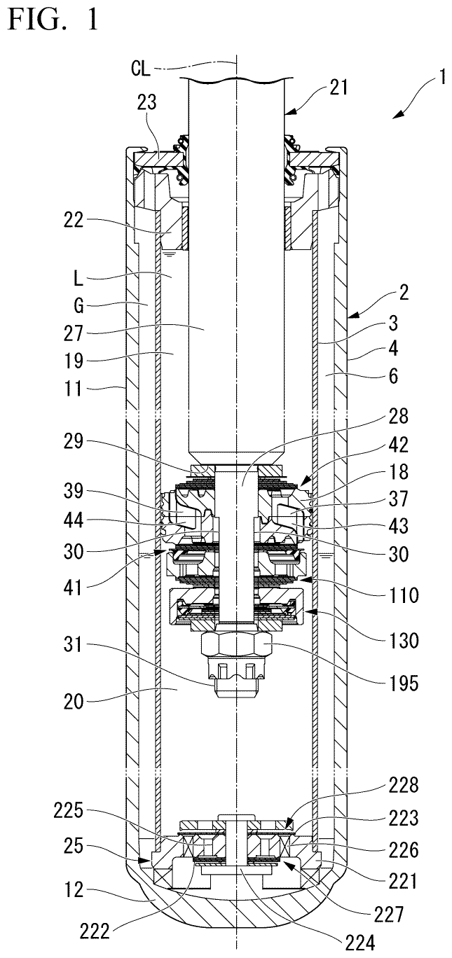

A shock absorber of a first embodiment will be described below with reference to FIGS. 1 to 4. Further, in the following, for convenience of explanation, an upper side in FIGS. 1 to 12 will be referred to using “upper” and a lower side in FIGS. 1 to 12 will be referred to using “lower”.

As shown in FIG. 1, a shock absorber 1 of the first embodiment is a dual-tube type hydraulic shock absorber. The shock absorber 1 is used in suspension devices of vehicles, specifically, automobiles. The shock absorber 1 includes a cylinder 2. An oil fluid L is sealed in the cylinder 2 as a working fluid. The cylinder 2 has an inner cylinder 3 and an outer cylinder 4. The inner cylinder 3 has a cylindrical shape. The outer cylinder 4 has a bottomed cylindrical shape. An inner diameter of the outer cylinder 4 is larger than an outer diameter of the inner cylinder 3. The inner cylinder 3 is disposed radially inward of the outer cylinder 4. A central axis of the inner cylinder 3 coincides with a central axis of the outer cylinder 4. A reservoir chamber 6 is provided between the inner cylinder 3 and the outer cylinder 4.

The outer cylinder 4 includes a barrel part 11 and a bottom part 12. The barrel part 11 and the bottom part 12 are integrally formed. The barrel part 11 has a cylindrical shape. The bottom part 12 closes a lower portion of the barrel part 11. A mounting eye (not shown) is fixed to the bottom part 12 on an outer side opposite to the barrel part 11 in an axial direction thereof.

The shock absorber 1 includes a piston 18. The piston 18 is inserted in the inner cylinder 3 of the cylinder 2. The piston 18 is slidably fitted in the inner cylinder 3 of the cylinder 2. The piston 18 partitions the inside of the inner cylinder 3 of the cylinder 2 into two chambers, an upper chamber 19 on one side and a lower chamber 20 on the other side. The upper chamber 19 is on a side opposite to the bottom part 12 with respect to the piston 18 in the axial direction of the cylinder 2. The lower chamber 20 is on the bottom part 12 side with respect to the piston 18 in the axial direction of the cylinder 2. The oil fluid L is sealed in the upper chamber 19 and the lower chamber 20 in the inner cylinder 3 as a working fluid. In the reservoir chamber 6 between the inner cylinder 3 and the outer cylinder 4, the oil fluid L and a gas G are sealed as working fluids.

The shock absorber 1 includes a piston rod 21. A first end portion of the piston rod 21 on one end side in the axial direction is disposed inside the inner cylinder 3 of the cylinder 2. The first end portion of the piston rod 21 is connected to the piston 18. A second end portion of the piston rod 21 on a side opposite to the first end portion in the axial direction extends from the cylinder 2 to the outside of the cylinder 2. The piston 18 is fixed to the piston rod 21. Therefore, the piston 18 and the piston rod 21 move together. In the shock absorber 1, a stroke in which the piston rod 21 moves in a direction to increase an amount of protrusion from the cylinder 2 is an extension stroke in which the entire length increases. In the shock absorber 1, a stroke in which the piston rod 21 moves in a direction to decrease an amount of protrusion from the cylinder 2 is a compression stroke in which the entire length decreases. In the shock absorber 1, the piston 18 moves to the upper chamber 19 side during the extension stroke. In the shock absorber 1, the piston 18 moves to the lower chamber 20 side during the compression stroke.

A rod guide 22 is fitted to an upper end opening side of the inner cylinder 3 and an upper end opening side of the outer cylinder 4. A seal member 23 is fitted to the outer cylinder 4 above the rod guide 22. The rod guide 22 and the seal member 23 are both annular. The piston rod 21 is inserted inside the rod guide 22 and the seal member 23 in a radial direction, and slides in an axial direction of them. The piston rod 21 extends from the inside of the cylinder 2 to the outside of the cylinder 2 with respect to the seal member 23.

The rod guide 22 restricts movement of the piston rod 21 in a radial direction with respect to the inner cylinder 3 and outer cylinder 4 of the cylinder 2. The piston rod 21 is fitted in the rod guide 22, and the piston 18 is fitted in the inner cylinder 3. Thereby, a central axis of the piston rod 21 and a central axis of the cylinder 2 coincide with each other. The rod guide 22 supports the piston rod 21 to be movable in an axial direction of the piston rod 21. An outer circumferential portion of the seal member 23 is in close contact with the barrel part 11 of the outer cylinder 4. An inner circumferential portion of the seal member 23 is in close contact with an outer circumferential portion of the piston rod 21. The piston rod 21 moves in the axial direction of the seal member 23 with respect to the seal member 23. The seal member 23 curbs the oil fluid L in the inner cylinder 3, and the high-pressure gas G and the oil fluid L in the reservoir chamber 6 leaking to the outside.

An outer circumferential portion of the rod guide 22 has a larger diameter at an upper portion than at a lower portion. The rod guide 22 is fitted to an inner circumferential portion of an upper end of the inner cylinder 3 at the lower portion with a smaller diameter. The rod guide 22 is fitted to an upper inner circumferential portion of the barrel part 11 of the outer cylinder 4 at the upper portion with a larger diameter.

A base valve 25 is installed on the bottom part 12 of the outer cylinder 4. The base valve 25 is positioned in the radial direction with respect to the outer cylinder 4. An inner circumferential portion of a lower end of the inner cylinder 3 is fitted to the base valve 25.

An upper end portion of the outer cylinder 4 is swaged inward in a radial direction of the outer cylinder 4. The seal member 23 is fixed to the cylinder 2 by being sandwiched between the swaged portion and the rod guide 22.

The piston rod 21 includes a main shaft part 27 and a mounting shaft part 28. Both the main shaft part 27 and the mounting shaft part 28 have a rod shape.

The mounting shaft part 28 has an outer diameter smaller than an outer diameter of the main shaft part 27. The mounting shaft part 28 is disposed inside the cylinder 2. The piston 18 is attached to the mounting shaft part 28. The main shaft part 27 has a shaft step part 29. The shaft step part 29 is provided at an end portion of the main shaft part 27 on the mounting shaft part 28 side in the axial direction. The shaft step part 29 extends in a direction perpendicular to the central axis of the piston rod 21.

The piston rod 21 has a groove part 30 formed on an outer circumferential portion of the mounting shaft part 28. The groove part 30 extends in an axial direction of the mounting shaft part 28. The groove part 30 is formed by cutting out the outer circumferential portion of the mounting shaft part 28 into a planar shape parallel to a central axis of the mounting shaft part 28. The groove part 30 is formed at two locations spaced apart from each other in a circumferential direction of the mounting shaft part 28. A screw part 31 is formed on an outer circumferential portion of an end portion of the mounting shaft part 28 on a side opposite to the main shaft part 27 with respect to the groove part 30 in the axial direction of the mounting shaft part 28.

The shock absorber 1 is connected to a vehicle body of a vehicle, for example, with a portion of the piston rod 21 protruding from the cylinder 2 disposed at an upper portion. At that time, the shock absorber 1 is connected to a wheel side of the vehicle with the mounting eye (not shown) provided on the cylinder 2 side disposed at a lower portion. Conversely, the cylinder 2 side of the shock absorber 1 may be connected to the vehicle body. In this case, the piston rod 21 of the shock absorber 1 is connected to the wheel side.

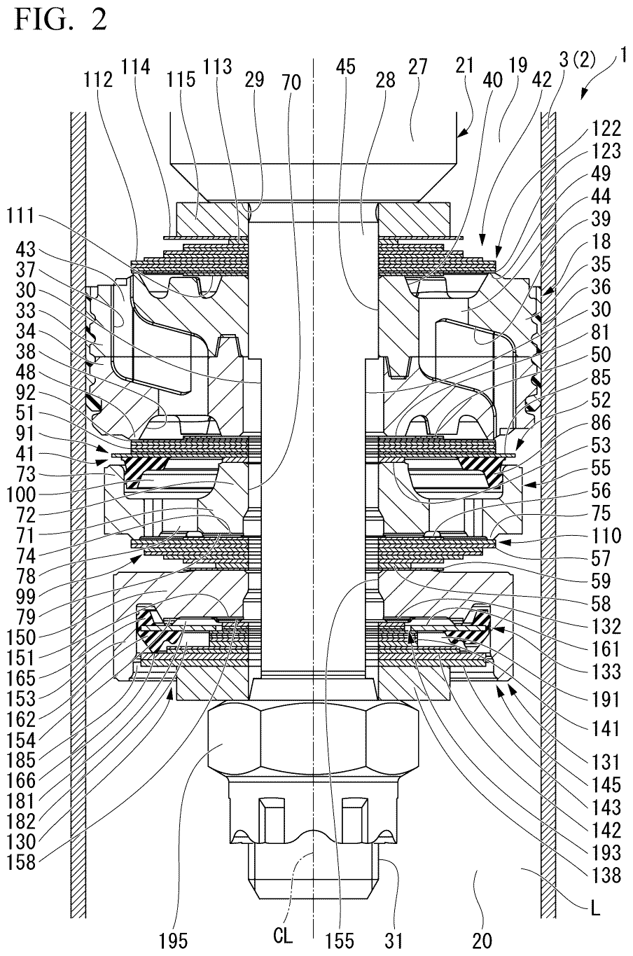

As shown in FIG. 2, the piston 18 includes a piston main body 35 and a slide member 36. The piston main body 35 is constituted by combining a segment body 33 and a segment body 34. The segment bodies 33 and 34 are both made of a metal, and both have an annular shape. In the segment bodies 33 and 34, an inner diameter of the segment body 33 is smaller than an inner diameter of the segment body 34. The slide member 36 is made of a synthetic resin and has an annular band shape. The slide member 36 is integrally attached to an outer circumferential surface of the piston main body 35 in a state in which the segment body 33 and the segment body 34 are combined. Thereby, the segment bodies 33 and 34 and the slide member 36 are integrated to form the piston 18. The piston 18 is fitted onto the mounting shaft part 28 of the piston rod 21. The piston 18 slides with respect to the inner cylinder 3 in the axial direction with the slide member 36 in contact with the inner cylinder 3.

A passage hole 37, a passage groove 38, a passage hole 39, and a passage groove 40 are provided in the piston main body 35.

The passage hole 37 extends in an axial direction of the piston main body 35. A plurality of passage holes 37 are formed in the piston main body 35 at intervals in a circumferential direction of the piston main body 35 (only one is shown in FIG. 2 because it is a cross section).

The passage hole 39 extends in the axial direction of the piston main body 35. A plurality of passage holes 39 are formed in the piston main body 35 at intervals in the circumferential direction of the piston main body 35 (only one is shown in FIG. 2 because it is a cross section). In the piston main body 35, the passage holes 37 and the passage holes 39 are alternately formed one by one at a regular pitch in the circumferential direction of the piston main body 35.

The passage groove 38 is formed in the segment body 34 of the piston main body 35 in an annular shape in a circumferential direction of the segment body 34. The passage groove 38 is formed at an end portion of the segment body 34 on a side opposite to the segment body 33 in the axial direction. All the passage holes 37 open to the passage groove 38 at the end portion side in the axial direction of the piston main body 35.

The passage groove 40 is formed in the segment body 33 of the piston main body 35 in an annular shape in a circumferential direction of the segment body 33. The passage groove 40 is formed at an end portion of the segment body 33 on a side opposite to the segment body 34 in the axial direction. All the passage holes 39 open to the passage groove 40 at the end portions on a side opposite to the passage groove 38 in the axial direction of the piston main body 35.

In the piston 18, the inside of the plurality of passage holes 37 and the inside of the passage groove 38 form a first passage 43. The first passage 43 penetrates the piston 18 in an axial direction of the piston 18. Therefore, the first passage 43 allows the upper chamber 19 and the lower chamber 20 to communicate with each other so that the oil fluid L, which is a working fluid, can flow between them due to movement of the piston 18.

In the piston 18, the inside of the plurality of passage holes 39 and the inside of the passage groove 40 form a first passage 44. The first passage 44 penetrates the piston 18 in the axial direction of the piston 18. Therefore, the first passage 44 allows the upper chamber 19 and the lower chamber 20 to communicate with each other so that the oil fluid L, which is a working fluid, can flow between them due to movement of the piston 18.

The first passage 43 and the first passage 44 are both provided in the piston 18.

A damping force mechanism 41 (first damping force mechanism) is provided at the first passage 43. The damping force mechanism 41 opens and closes the first passage 43 to generate a damping force. The damping force mechanism 41 is disposed on the lower chamber 20 side which is one end side in the axial direction of the piston 18 to be attached to the piston rod 21. Thereby, the first passage 43 serves as a passage through which the oil fluid L as a working fluid moves from the upper chamber 19 toward the lower chamber 20 due to movement of the piston 18 to the upper chamber 19 side. That is, the first passage 43 is a passage through which the oil fluid L moves from the upper chamber 19 on an upstream side to the lower chamber 20 on a downstream side during the extension stroke. The damping force mechanism 41 is an extension-side damping force generation mechanism that generates a damping force by suppressing a flow of the oil fluid L from the first passage 43 to the lower chamber 20 that occurs during the extension stroke.

A damping force mechanism 42 (first damping force mechanism) is provided at the first passage 44. The damping force mechanism 42 opens and closes the first passage 44 to generate a damping force. The damping force mechanism 42 is disposed on the upper chamber 19 side which is the other end side in the axial direction of the piston 18 to be attached to the piston rod 21. Thereby, the first passage 44 serves as a passage through which the oil fluid L moves from the lower chamber 20 toward the upper chamber 19 due to movement of the piston 18 to the lower chamber 20 side. That is, the first passage 44 is a passage through which the oil fluid L moves from the lower chamber 20 on an upstream side to the upper chamber 19 on a downstream side during the compression stroke. The damping force mechanism 42 is a compression-side damping force generation mechanism that generates a damping force by suppressing a flow of the oil fluid L from the first passage 44 to the upper chamber 19 that occurs during the compression stroke.

The piston main body 35 has an insertion hole 45 formed to penetrate the piston main body 35 in the axial direction at a center in the radial direction thereof. The mounting shaft part 28 of the piston rod 21 is inserted through the insertion hole 45. The insertion hole 45 has a smaller diameter at a portion formed in the segment body 33 on the upper chamber 19 side than at a portion formed in the segment body 34 on the lower chamber 20 side in the axial direction. The piston main body 35 fits onto the mounting shaft part 28 of the piston rod 21 in the segment body 33 having a smaller inner diameter as described above.

A valve seat part 48 is formed at an end portion of the piston main body 35 on the lower chamber 20 side in the axial direction. The valve seat part 48 has an annular shape. The valve seat part 48 is disposed on an outer side of an opening of the passage groove 38 on the lower chamber 20 side in the radial direction of the piston main body 35. The valve seat part 48 constitutes a part of the damping force mechanism 41.

A valve seat part 49 is formed at an end portion of the piston main body 35 on the upper chamber 19 side in the axial direction. The valve seat part 49 has an annular shape. The valve seat part 49 is disposed on an outer side of an opening of the passage groove 40 on the upper chamber 19 side in the radial direction of the piston main body 35. The valve seat part 49 constitutes a part of the damping force mechanism 42.

In the piston main body 35, openings of all the passage holes 39 on the lower chamber 20 side are disposed on a side of the valve seat part 48 opposite to the passage groove 38 in the radial direction of the piston main body 35. In the piston main body 35, openings of all the passage holes 37 on the upper chamber 19 side are disposed on a side of the valve seat part 49 opposite to the passage groove 40 in the radial direction of the piston main body 35.

A plurality of (specifically, two) discs 50, a plurality of (specifically, five) discs 51, one pilot disc 52, one disc 53, one pilot case 55, one disc 56, a plurality of (specifically, six) discs 57, one disc 58, and one disc 59 are provided on the valve seat part 48 side in the axial direction of the piston 18 in order from the piston 18 side in the axial direction of the piston 18.

The discs 50, 51, 53, and 56 to 59, and the pilot case 55 are all made of a metal. The discs 50, 51, 53, and 56 to 59 are all formed in a perforated circular flat plate shape with a constant thickness. The mounting shaft part 28 of the piston rod 21 is fitted inside all the discs 50, 51, 53, and 56 to 59. Both the pilot disc 52 and the pilot case 55 have an annular shape. The mounting shaft part 28 of the piston rod 21 is fitted inside both the pilot disc 52 and the pilot case 55.

The pilot case 55 has a bottomed cylindrical shape. A through hole 70 is formed at a center of the pilot case 55 in the radial direction. The through hole 70 penetrates the pilot case 55 in an axial direction thereof. The through hole 70 has a smaller diameter on the piston 18 side in the axial direction than on a side opposite to the piston 18, and the mounting shaft part 28 of the piston rod 21 is fitted in the small diameter portion.

The pilot case 55 has a bottom part 71, an inner cylindrical part 72, an outer cylindrical part 73, an inner seat part 74, and a valve seat part 75.

The bottom part 71 has a perforated disc shape. A passage hole 78 penetrating the bottom part 71 in an axial direction of the bottom part 71 is formed in the bottom part 71 on a radially outward side with respect to the through hole 70.

The inner cylindrical part 72 has a cylindrical shape and protrudes from an inner circumferential edge portion of the bottom part 71 to the piston 18 side in the axial direction of the bottom part 71.

The outer cylindrical part 73 has a cylindrical shape and protrudes from an outer circumferential edge portion of the bottom part 71 to the same side as the inner cylindrical part 72 in the axial direction of the bottom part 71.

The passage hole 78 is disposed between the inner cylindrical part 72 and the outer cylindrical part 73 in a radial direction of the bottom part 71.

The inner seat part 74 has an annular shape, and slightly protrudes from the inner circumferential edge portion of the bottom part 71 to a side opposite to the inner cylindrical part 72 in the axial direction. A passage groove 79 penetrating the inner seat part 74 in the radial direction is formed in the inner seat part 74.

The valve seat part 75 has an annular shape with a larger diameter than the inner seat part 74. The valve seat part 75 protrudes from the bottom part 71 to the same side as the inner seat part 74 in the axial direction of the bottom part 71 at an outer side of the inner seat part 74 in a radial direction of the inner seat part 74.

The passage hole 78 is disposed between the inner seat part 74 and the valve seat part 75 in the radial direction of the bottom part 71. A passage in the passage groove 79 of the inner seat part 74 is in constant communication with a passage in the groove part 30 of the piston rod 21 and a passage in the passage hole 78.

Of the plurality of discs 50, the disc 50 on the piston 18 side in the axial direction is in contact with a portion of the piston 18 on a radially inner side of the passage groove 38. A notch 81 is formed in the discs 50. A passage in the notch 81 is a throttle, and is in constant communication with the first passage 43 of the piston 18 and the passage in the groove part 30 of the piston rod 21.

Of the plurality of discs 51, the disc 51 closest to the piston 18 side in the axial direction is in contact with the valve seat part 48 of the piston 18. The plurality of discs 51 open and close an opening of the first passage 43 formed in the piston 18 by being separated from and coming into contact with the valve seat part 48.

The pilot disc 52 is formed of a disc 85 and a seal member 86.

The disc 85 is made of a metal and has a perforated circular flat plate shape. The mounting shaft part 28 of the piston rod 21 is fitted inside the disc 85. Of the plurality of discs 51, the disc 51 on a side furthest away from the piston 18 in the axial direction is in contact with the disc 85 of the pilot disc 52.

The seal member 86 is made of rubber and is adhered to a side of the disc 85 opposite to the piston 18 in the axial direction by baking. The seal member 86 is fixed to an outer circumferential side of the disc 85 and has an annular shape. The seal member 86 is fitted in a liquid-tight manner to an inner circumferential portion of the outer cylindrical part 73 of the pilot case 55 over the entire circumference. The seal member 86 is slidable in the axial direction with respect to the inner circumferential portion of the outer cylindrical part 73. The seal member 86 constantly seals a gap between the pilot disc 52 and the outer cylindrical part 73.

The plurality of discs 51 and the pilot disc 52 constitute a damping valve 91. The damping valve 91 can be separated from and seated on the valve seat part 48 of the piston 18. The damping valve 91 can open the first passage 43 to the lower chamber 20 by being separated from the valve seat part 48. A space between the damping valve 91 and the valve seat part 48 of the piston 18 forms the first passage 43. When the damping valve 91 is separated from the valve seat part 48 of the piston 18 and opens, the oil fluid L from the first passage 43 is allowed to flow into the lower chamber 20 through between the piston 18 and the outer cylindrical part 73 of the pilot case 55. At that time, the damping valve 91 suppresses a flow of the oil fluid L between itself and the valve seat part 48. The damping valve 91 constitutes the extension-side damping force mechanism 41. In the damping valve 91, a fixed orifice 92 allowing the first passage 43 to communicate with the lower chamber 20 even when the disc 51 is in contact with the valve seat part 48 is formed in at least the disc 51 of the plurality of discs 51 that comes into contact with the valve seat part 48. The fixed orifice 92 constitutes the first passage 43 and constitutes the damping force mechanism 41.

The disc 53 is in contact with the disc 85 of pilot disc 52. The disc 53 is in contact with the inner cylindrical part 72 of the pilot case 55.

The disc 56 is in contact with the inner seat part 74 of the pilot case 55.

Of the plurality of discs 57, the disc 57 on the disc 56 side in the axial direction can be seated on the valve seat part 75. The plurality of discs 57 constitute a disc valve 99. The disc valve 99 can be separated from and seated on the valve seat part 75.

The disc 58 has an outer diameter smaller than a minimum outer diameter of the disc valve 99.

The disc 59 has an outer diameter larger than the outer diameter of the disc 58.

A space between the bottom part 71, the inner cylindrical part 72, and the outer cylindrical part 73 of the pilot case 55, and the pilot disc 52 and disc 53, a space between the bottom part 71, the inner seat part 74, and the valve seat part 75 of the pilot case 55, and the disc 56 and disc valve 99, and the inside of the passage hole 78 of the pilot case 55 serve as a back pressure chamber 100. The back pressure chamber 100 applies a pressure to the plurality of discs 51 in a direction of the piston 18 via the pilot disc 52. In other words, the back pressure chamber 100 applies an internal pressure to the damping valve 91 in a valve closing direction in which the damping valve 91 is seated on the valve seat part 48. The plurality of discs 51, the pilot disc 52, and the back pressure chamber 100 constitute a part of the damping force mechanism 41. The back pressure chamber 100 is in constant communication with the passage in the groove part 30 of the piston rod 21 through the passage in the passage groove 79 of the pilot case 55.

The passage in the notch 81 of the disc 50, the passage in the groove part 30 of the piston rod 21, and the passage in the passage groove 79 of the pilot case 55 allow constant communication between the first passage 43 of the piston 18 and the back pressure chamber 100 to introduce the oil fluid L from the first passage 43 into the back pressure chamber 100. The extension-side damping force mechanism 41 controls an opening of the damping valve 91 using the pressure in the back pressure chamber 100.

The disc valve 99 allows communication between the back pressure chamber 100 and the lower chamber 20 by being separated from the valve seat part 75. At that time, the disc valve 99 suppresses a flow of the oil fluid L between itself and the valve seat part 75.

The disc valve 99 and the valve seat part 75 constitute a damping force mechanism 110. The damping force mechanism 110 allows communication between the back pressure chamber 100 and the lower chamber 20 when the disc valve 99 is separated from the valve seat part 75. At that time, the damping force mechanism 110 generates a damping force by suppressing a flow of the oil fluid L between the back pressure chamber 100 and the lower chamber 20. During the extension stroke, the damping force mechanism 110 allows the oil fluid L to flow from the upper chamber 19 to the lower chamber 20 via the first passage 43, the passage in the notch 81, the passage in the groove part 30, the passage in the passage groove 158, and the back pressure chamber 100. The damping force mechanism 110 serves as an extension-side damping force generation mechanism that generates a damping force by suppressing a flow of the oil fluid L from the back pressure chamber 100 to the lower chamber 20 that occurs during the extension stroke.

One disc 111, a plurality of (specifically, nine) discs 112, one disc 113, one disc 114, and one annular member 115 are provided on the valve seat part 49 side of the piston 18 in the axial direction in order from the piston 18 side in the axial direction of the piston 18. The discs 111 to 114 and the annular member 115 are all made of a metal. All the discs 111 to 114 and the annular member 115 have a perforated circular flat plate shape with a constant thickness. The mounting shaft part 28 of the piston rod 21 is fitted inside all the discs 111 to 114 and the annular member 115.

The disc 111 is in contact with a portion of the piston 18 on a radially inner side of the passage groove 40.

Of the plurality of discs 112, the disc 112 closest to the piston 18 side in the axial direction is in contact with the valve seat part 49 of the piston 18. The plurality of discs 112 open and close an opening of the first passage 44 formed in the piston 18 by being separated from and coming into contact with the valve seat part 49.

The plurality of discs 112 constitute a disc valve 122. The disc valve 122 can be separated from and seated on the valve seat part 49. The disc valve 122 can open the first passage 44 to the upper chamber 19 by being separated from the valve seat part 49. A space between the disc valve 122 and the valve seat part 48 forms the first passage 44. When the disc valve 122 opens by being separated from the valve seat part 49 of the piston 18, the oil fluid L from the first passage 44 is allowed to flow into the upper chamber 19. At that time, the disc valve 122 suppresses a flow of the oil fluid L between itself and the valve seat part 49. Therefore, the disc valve 122 suppresses a flow of the oil fluid L from the lower chamber 20 to the upper chamber 19 through the first passage 44. The disc valve 122 and the valve seat part 49 constitute the compression-side damping force mechanism 42. The disc valve 122 includes a fixed orifice 123 formed to allow the first passage 44 to communicate with the upper chamber 19 even when the disc valve 122 is in contact with the valve seat part 49. The fixed orifice 123 also constitutes the damping force mechanism 42.

The disc 113 has an outer diameter smaller than a minimum outer diameter of the disc valve 122.

The disc 114 has an outer diameter larger than the outer diameter of the disc 113. The disc 114 and the annular member 115 come into contact with the disc valve 122 when the disc valve 122 is deformed in an opening direction to suppress deformation of the disc valve 122 in the opening direction beyond a specified limit. The annular member 115 is in contact with the shaft step part 29 of the piston rod 21.

A frequency sensitive mechanism 130 (second damping force mechanism) is provided on a side of the disc 59 opposite to the disc 58 in the axial direction. The frequency sensitive mechanism 130 varies the damping force according to a frequency of axial movement of the piston 18 (hereinafter referred to as a piston frequency).

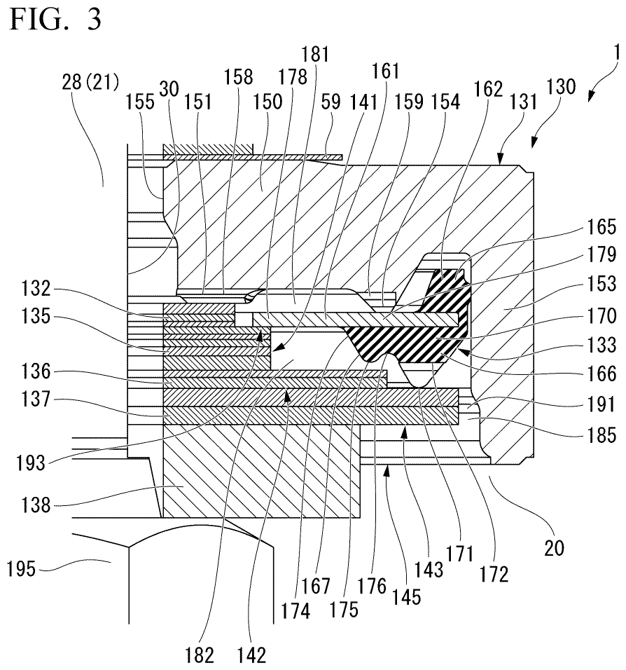

As shown in FIG. 3, the frequency sensitive mechanism 130 includes one case member 131 on the disc 59 side in the axial direction. The frequency sensitive mechanism 130 includes a plurality of (specifically, three) discs 132 having the same outer diameter and the same inner diameter, and one partition member 133 on a side of the case member 131 opposite to the disc 59 in the axial direction. The frequency sensitive mechanism 130 includes a plurality of (specifically, five) discs 135 having the same outer diameter and the same inner diameter, a plurality of (specifically, two) discs 136 having the same outer diameter and the same inner diameter, and a plurality of (specifically, two) discs 137 having the same outer diameter and the same inner diameter on a side of the discs 132 and the partition member 133 opposite to the disc 59 in the axial direction in order from the discs 132 and the partition member 133 side. An annular member 138 is provided on a side of the disc 137 opposite to the disc 136 in the axial direction.

The plurality of discs 135 constitute a support member 141. The plurality of discs 136 constitute a valve seat member 142. The plurality of discs 137 constitute a cover member 143.

The case member 131, the discs 132 and 135 to 137 and the annular member 138 are all made of a metal. All the discs 132 and 135 to 137 and the annular member 138 have a perforated circular flat plate shape with a constant thickness. In other words, the discs 132 and 135 to 137 and the annular member 138 are each formed of an annular plate-shaped member. The discs 132 and 135 to 137, the partition member 133, and the annular member 138 are all disposed radially inward of the case member 131. The mounting shaft part 28 of the piston rod 21 is fitted inside all the case member 131, the discs 132 and 135 to 137, and the annular member 138. Therefore, the case member 131, the discs 132 and 135 to 137, and the annular member 138 are all made to coincide with the piston rod 21 in central axis. The mounting shaft part 28 of the piston rod 21 and the plurality of discs 132 are inserted through an inner circumferential side of the partition member 133 with a gap in the radial direction. In the frequency sensitive mechanism 130, the case member 131 and the discs 132 and 135 to 137 constitute a valve case 145. The frequency sensitive mechanism 130 has the partition member 133 inside the valve case 145.

The case member 131 has a bottomed cylindrical shape. A through hole 155 penetrating the case member 131 in the axial direction is formed at a center of the case member 131 in the radial direction. As shown in FIG. 2, the through hole 155 has a smaller diameter on the piston 18 side in the axial direction than on a side opposite to the piston 18, and the mounting shaft part 28 of the piston rod 21 is fitted in the small diameter portion.

As shown in FIG. 3, the case member 131 includes a bottom part 150, a protruding part 151, a cylindrical part 153, and a seat part 154.

The bottom part 150 has a perforated disc shape. The bottom part 150 has a constant radial width over the entire circumference. The through hole 155 is formed in the bottom part 150.

The protruding part 151 has an annular shape. The protruding part 151 protrudes from an inner circumferential edge portion of the bottom part 150 to a side of the bottom part 150 opposite to the disc 59 in the axial direction. A passage groove 158 penetrating the protruding part 151 in the radial direction is formed in the protruding part 151. A passage in the passage groove 158 is a throttle and communicates with the passage in the groove part 30 of the piston rod 21.

The cylindrical part 153 has a cylindrical shape with an inner diameter larger than an outer diameter of the protruding part 151. The cylindrical part 153 extends from an outer circumferential edge portion of the bottom part 150 to the same side as the protruding part 151 in an axial direction of the bottom part 150.

The seat part 154 has an annular shape. The seat part 154 protrudes from a position between the protruding part 151 and the cylindrical part 153 in a radial direction of the bottom part 150 to the same side as the protruding part 151 and the cylindrical part 153 in the axial direction of the bottom part 150. The seat part 154 has a notch part 159 formed at a distal end portion on a protruding side to penetrate the distal end portion in a radial direction of the seat part 154. A plurality of notch parts 159 are formed in the seat part 154 at intervals in a circumferential direction of the seat part 154. Therefore, the distal end portion on the protruding side of the seat part 154 is intermittently cut out in the circumferential direction of the seat part 154. A height position of the distal end of the seat part 154 in the axial direction of the bottom part 150 is higher than a height position of the distal end of the protruding part 151.

The disc 132 has a constant outer diameter over the entire circumference and a constant radial width over the entire circumference. The outer diameter of the disc 132 is slightly smaller than an outer diameter of an end surface of the protruding part 151 on a side opposite to the bottom part 150 in the axial direction.

The disc 135 constituting the support member 141 has a constant outer diameter over the entire circumference and a constant radial width over the entire circumference. The disc 135 has an outer diameter larger than the outer diameter of the disc 132.

The disc 136 constituting the valve seat member 142 has a constant outer diameter over the entire circumference and a constant radial width over the entire circumference. The disc 136 has an outer diameter larger than the outer diameter of the disc 135.

The disc 137 constituting the cover member 143 has a constant outer diameter over the entire circumference and a constant radial width over the entire circumference. The disc 137 has an outer diameter larger than the outer diameter of the disc 136.

The discs 132 and 135 to 137, the partition member 133, and the annular member 138 are all disposed radially inward of the cylindrical part 153. The discs 132 and 135 to 137 and the partition member 133 are all disposed within a range of the cylindrical part 153 in the axial direction of cylindrical part 153. A part of the annular member 138 is disposed within the range of the cylindrical part 153 in an axial direction of the cylindrical part 153, and a remaining part thereof is disposed outside the range of the cylindrical part 153 in the axial direction of the cylindrical part 153.

The partition member 133 is formed of a valve disc 161 and an elastic seal member 162. The partition member 133 is disposed at a position between the cylindrical part 153 of the case member 131 and the plurality of discs 132 in the radial direction.

The valve disc 161 is made of a metal. The valve disc 161 has a perforated circular flat plate shape with a constant thickness. The valve disc 161 has a constant outer diameter over the entire circumference and a constant radial width over the entire circumference. The mounting shaft part 28 of the piston rod 21 and the plurality of discs 132 are inserted through an inner circumferential side of the valve disc 161. The valve disc 161 is elastically deformable, that is, bendable. The valve disc 161 has an inner diameter that allows the plurality of discs 132 to be disposed inside with a gap in the radial direction. The outer diameter of the valve disc 161 is smaller than the inner diameter of the cylindrical part 153. The valve disc 161 has an axial thickness smaller than a total thickness of all the discs 132.

The elastic seal member 162 is made of rubber and has an annular shape. The elastic seal member 162 is adhered to an outer circumferential side of the valve disc 161. The elastic seal member 162 is provided integrally with the valve disc 161 by being baked to the valve disc 161.

The elastic seal member 162 has a seal part 165, a contact part 166, and a valve closing part 167.

The seal part 165 has an annular shape and is fixed to the outer circumferential side of the valve disc 161 over the entire circumference. The seal part 165 protrudes from the valve disc 161 toward the bottom part 150 of the case member 131 in an axial direction of the partition member 133.

The contact part 166 has an annular shape, and protrudes from the valve disc 161 to a side opposite to the bottom part 150 in the axial direction of the partition member 133. In the contact part 166, a base end portion 170 on the valve disc 161 side in the axial direction of the partition member 133 is fixed to an outer circumferential edge portion of the valve disc 161 by baking. The seal part 165 and the base end portion 170 of the contact part 166 are connected and integrated on the outer circumferential side of the valve disc 161.

An outer circumferential portion of the contact part 166 has an outer diameter that decreases with distance away from the valve disc 161 in the axial direction of the partition member 133. An inner circumferential portion of a distal end portion 171 on a protruding side of the contact part 166 has an inner diameter that increases with distance away from the valve disc 161 in the axial direction of the partition member 133. Therefore, a cross-sectional shape of the distal end portion 171 of the contact part 166 in a plane including a central axis of the partition member 133 is a tapered single-chevron shape that becomes thinner with distance away from the valve disc 161 in the axial direction of the partition member 133.

A notch part 172 penetrating the distal end portion 171 in a radial direction of the partition member 133 is formed in the distal end portion 171 of the contact part 166. A plurality of notch parts 172 are formed in the contact part 166 at intervals in a circumferential direction of the partition member 133. Therefore, the distal end portion 171 of the contact part 166 is intermittently cut out in the circumferential direction of the partition member 133.

The valve closing part 167 has an annular shape and protrudes from the valve disc 161 to a side opposite to the bottom part 150 in the axial direction of the partition member 133. The valve closing part 167 is provided on an inner circumferential side of the contact part 166 in the radial direction of the partition member 133. In the valve closing part 167, a base end portion 174 on the valve disc 161 side in the axial direction of the partition member 133 is fixed by being baked to an inner side of the contact part 166 of the valve disc 161 in the radial direction of the partition member 133. The base end portion 174 of the valve closing part 167 is connected to and integrated with the base end portion 170 of the contact part 166.

An inner circumferential portion of the valve closing part 167 has an inner diameter that increases with distance away from the valve disc 161 in the axial direction of the partition member 133. An outer circumferential portion of a distal end portion 175 on a protruding side of the valve closing part 167 has an outer diameter that decreases with distance away from the valve disc 161 in the axial direction of the partition member 133. Therefore, a cross-sectional shape of the distal end portion 175 of the valve closing part 167 in a plane including the central axis of the partition member 133 is a tapered single-chevron shape that becomes thinner with distance away from the valve disc 161 in the axial direction of the partition member 133. Therefore, the partition member 133 has a double-chevron shape formed of the distal end portion 171 of the contact part 166 and the distal end portion 175 of the valve closing part 167. A cross-sectional shape of the distal end portion 175 of the valve closing part 167 in a plane including the central axis of the partition member 133 is consistent over the entire circumference. A protrusion height of the valve closing part 167 from the valve disc 161 is smaller than a protrusion height of the contact part 166 from the valve disc 161.

The elastic seal member 162 has a recessed part 176 between the contact part 166 and the valve closing part 167 in the radial direction of the partition member 133. The recessed part 176 is recessed to the valve disc 161 side from the distal end portion 171 of the contact part 166 and the distal end portion 175 of the valve closing part 167 in the axial direction of the partition member 133. The recessed part 176 has an annular shape that is continuous over the entire circumference of the partition member 133.

As described above, there is a radial gap between the partition member 133 and the plurality of discs 132. The partition member 133 is press-fitted to the cylindrical part 153 of the case member 131 at the seal part 165. Due to the press fitting, the partition member 133 is centered to be coaxially disposed with the case member 131, the plurality of discs 132 and the piston rod 21. At that time, the seal part 165 of the partition member 133 is in contact with the cylindrical part 153 over the entire circumference with a fastening allowance in the radial direction. In other words, the seal part 165 of the partition member 133 is in close contact with the cylindrical part 153 of the case member 131 over the entire circumference. Therefore, the seal part 165 is fitted in a liquid-tight manner to the cylindrical part 153 of the case member 131 over the entire circumference.

The seal part 165 is capable of sliding in the axial direction of the cylindrical part 153 while remaining in close contact with the cylindrical part 153 over the entire circumference. Therefore, the seal part 165 of the elastic seal member 162 constantly seals a gap between the partition member 133 and the cylindrical part 153. The seal part 165 is on a radially outer side of the seat part 154 of the case member 131. The valve disc 161 of the partition member 133 is seated on the seat part 154.

The disc 135 constituting the support member 141 has an outer diameter larger than an inner diameter of the valve disc 161, that is, an inner diameter of the partition member 133. The support member 141 is disposed on a side of the valve disc 161 opposite to the bottom part 150 in the axial direction, and is in pressure contact with a first support part 178 on the inner circumferential side of the valve disc 161 over the entire circumference. Thereby, a gap between the support member 141 and the valve disc 161, that is, the partition member 133, is closed.

As described above, the partition member 133 is centered with respect to the valve case 145 by the seal part 165 coming into contact with the cylindrical part 153 over the entire circumference.

In this state, the first support part 178 of the partition member 133 on the inner circumferential side of the valve disc 161 is disposed between the protruding part 151 and the support member 141 in the axial direction. Then, the first support part 178 is supported by the support member 141 with one surface on a side opposite to the bottom part 150 in the axial direction in contact with the support member 141. In other words, the partition member 133 includes the first support part 178 in which one surface on a radially inner side is supported by the support member 141. The first support part 178 is supported by the support member 141 on only one side without being clamped from both sides. The first support part 178 of the partition member 133 on the inner circumferential side of the valve disc 161 is movable between the protruding part 151 and the support member 141 within a range of the entire axial length of the plurality of (specifically, three) discs 132.

In the partition member 133, a second support part 179 disposed radially outward from the first support part 178 of the valve disc 161 comes into contact with the seat part 154 and is supported by the seat part 154 on one surface on the bottom part 150 side in the axial direction. In other words, the partition member 133 has the second support part 179 that is disposed radially outward from the first support part 178 and whose one surface is supported by the seat part 154. The second support part 179 is supported by the seat part 154 on only one side without being clamped from both sides.

Therefore, the partition member 133 has a simple support structure in which one surface side of the first support part 178 of the valve disc 161 is supported by the support member 141, and the other surface side of the second support part 179, which is radially outward from the first support part 178, of the valve disc 161 is supported by the seat part 154. In other words, the valve disc 161 is not clamped in the axial direction.

The contact part 166 of the partition member 133 is disposed on a side of the partition member 133 opposite to the bottom part 150 in the axial direction. The distal end portion 171 of the contact part 166 is disposed on an outer side with respect to the second support part 179 in the radial direction of the partition member 133. The contact part 166 is in contact with the cover member 143 formed of the plurality of discs 137 at the distal end portion 171. The contact part 166 biases the second support part 179 side in the radial direction of the valve disc 161 to the seat part 154 side in the axial direction of the valve disc 161.

The valve closing part 167 of the partition member 133 is disposed on a side of the partition member 133 opposite to the bottom part 150 in the axial direction. The distal end portion 175 of the valve closing part 167 is disposed slightly inward of the second support part 179 in the radial direction of the partition member 133. The distal end portion 175 of the valve closing part 167 overlaps the valve seat member 142 formed of the plurality of discs 136 in position in the radial direction of the partition member 133. In the partition member 133, when the valve disc 161 deforms in the axial direction of the partition member 133, the valve closing part 167 is displaced with respect to the valve seat member 142, and thereby the distal end portion 175 of the valve closing part 167 is separated from and seated on the valve seat member 142. Further, the partition member 133 is not limited to being displaced by deformation in the axial direction, and may also be displaced by movement in the axial direction.

The partition member 133 has an annular plate shape as a whole and is elastically deformable, that is, bendable as a whole. The valve disc 161 of the partition member 133 is bendable in a tapered shape such that the second support part 179 is separated from the seat part 154 while the first support part 178 remains in contact with the support member 141. When bending in this manner, the valve disc 161 bends to move the second support part 179 to a side opposite to the bottom part 150 farther than the first support part 178 in the axial direction of the case member 131. At that time, the valve disc 161 elastically deforms the contact part 166 that is in contact with the cover member 143. Then, when the valve disc 161 bends by a predetermined amount, the distal end portion 175 of the valve closing part 167 is brought into contact with the valve seat member 142.

The plurality of discs 137 constituting the cover member 143 have an outer diameter larger than the outer diameter of the disc 136 and smaller than the inner diameter of the cylindrical part 153. The cover member 143 is in contact with the disc 136 and the annular member 138 on an inner circumferential side, and is in contact with the contact part 166 of the partition member 133 on an outer circumferential side. The cover member 143 suppresses movement of the partition member 133 to a side opposite to the bottom part 150 in the axial direction.

The seat part 154 of the case member 131 supports the second support part 179 of the valve disc 161 of the partition member 133 from one axial side. The support member 141 supports the first support part 178 of the valve disc 161 on an inner circumferential side of the seat part 154 from the other axial side. A shortest distance between the seat part 154 and the support member 141 in the axial direction is slightly smaller than a thickness of the valve disc 161 in the axial direction. Therefore, the valve disc 161, with it slightly elastically deformed, comes into pressure contact with both the seat part 154 and the support member 141 by its own elastic force.

The partition member 133 is provided inside the valve case 145 and partitions the inside of the valve case 145 into a first chamber 181 and a second chamber 182. The first chamber 181 is provided between the bottom part 150 and the partition member 133 in an axial direction of the valve case 145. In other words, the first chamber 181 is on the bottom part 150 side with respect to the partition member 133 in the axial direction of the valve case 145. The second chamber 182 is provided between the partition member 133, and the valve seat member 142 and cover member 143 in the axial direction of the valve case 145. In other words, the second chamber 182 is on a side opposite to the bottom part 150 with respect to the partition member 133 in the axial direction of the valve case 145, that is, on an opening side of the case member 131.

Both the first chamber 181 and the second chamber 182 are variable in capacity, and the capacities change due to a displacement caused by deformation of the partition member 133. The first chamber 181 is in constant communication with the passage in the groove part 30 of the piston rod 21 through the passage in the passage groove 158 of the case member 131. The first chamber 181 is in constant communication with the upper chamber 19 via the passage in the passage groove 158, the passage in the groove part 30, the passage in the notch 81 shown in FIG. 2, and the first passage 43. Also, the first chamber 181 is in constant communication with the back pressure chamber 100 via the passage in the passage groove 158 shown in FIG. 3, the passage in the groove part 30, and the passage in the passage groove 79 shown in FIG. 2.

As shown in FIG. 3, in a state in which the valve closing part 167 of the partition member 133 is separated from the valve seat member 142, the entire second chamber 182 communicates with the lower chamber 20 via a passage part 185 between the cover member 143 and the cylindrical part 153 of the case member 131.

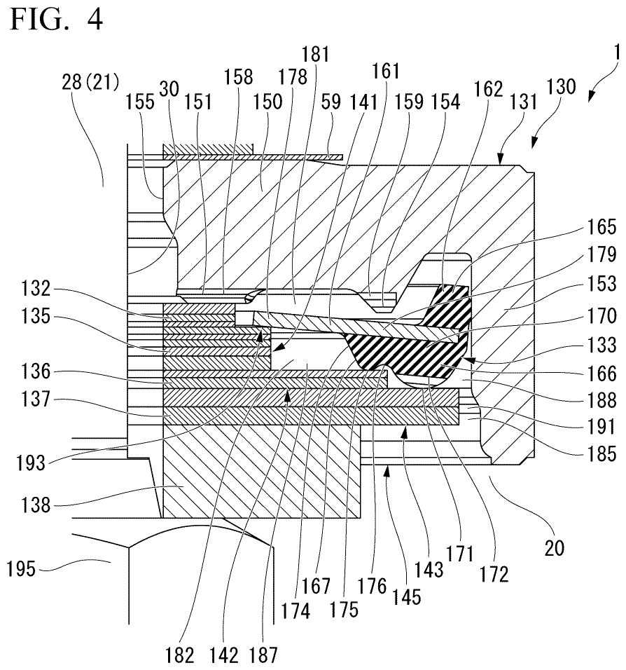

As shown in FIG. 4, in a state in which the valve closing part 167 is in contact with the valve seat member 142 over the entire circumference due to the deformation of the partition member 133, the second chamber 182 is partitioned into a pressure chamber 187 on a radially inner side of the valve closing part 167 and a communication chamber 188 on a radially outer side of the valve closing part 167. The communication chamber 188 communicates with the lower chamber 20 through the passage part 185. The pressure chamber 187 does not communicate with the communication chamber 188, and therefore neither communicates with the lower chamber 20.

During the extension stroke, the oil fluid L from the upper chamber 19 shown in FIG. 2 is introduced into the first chamber 181 via the first passage 43, the passage in the notch 81 of the disc 50, the passage in the groove part 30 of the piston rod 21, and the passage in the passage groove 158 of the case member 131 shown in FIG. 3. Then, the valve disc 161 of the partition member 133 bends in a tapered shape so that the second support part 179 is separated from the bottom part 150 further than the first support part 178 in the axial direction of the case member 131 using a contact point with the support member 141 that is in contact at the first support part 178 as a fulcrum. At that time, the valve disc 161 compressively deforms the contact part 166 that comes into contact with the cover member 143 in the axial direction of the case member 131.

Due to the displacement of the partition member 133 including the valve disc 161 as described above, the partition member 133 increases a volume of the first chamber 181. Here, during this displacement of the partition member 133, a volume of the second chamber 182 decreases. At that time, the oil fluid L in the second chamber 182 flows into the lower chamber 20 through the passage part 185.

Here, during the extension stroke, in a state in which the displacement of the partition member 133 is smaller than a predetermined amount, the valve closing part 167 is separated from the valve seat member 142, and therefore the oil fluid L flows from the entire second chamber 182 to the lower chamber 20 through the passage part 185.

On the other hand, during the extension stroke, in a state in which the displacement of the partition member 133 is equal to or larger than the predetermined amount, the valve closing part 167 comes into contact with the valve seat member 142 over the entire circumference as shown in FIG. 4, and partitions the second chamber 182 into the pressure chamber 187 and the communication chamber 188. Therefore, the second chamber 182 is placed in a state in which the communication chamber 188 communicates with the lower chamber 20 through the passage part 185, but the pressure chamber 187 does not communicate with the lower chamber 20.

That is, in the frequency sensitive mechanism 130, the valve disc 161 of the partition member 133 is displaced by the oil fluid L that has flowed into the first chamber 181 due to movement of the piston 18 during the extension stroke, and discharges at least some of the oil fluid L in the second chamber 182 into the lower chamber 20 in the cylinder 2. Also, as shown in FIG. 4, in the frequency sensitive mechanism 130, the valve closing part 167 forms the closed pressure chamber 187 between the valve seat member 142 in a second passage 191 and the partition member 133 to restrict movement of the oil fluid L in the pressure chamber 187.

As shown in FIG. 2, the first passage 43, the passage in the notch 81, the passage in the groove part 30 of the piston rod 21, the passage in the passage groove 158, the first chamber 181, the second chamber 182, and the passage part 185 constitute the second passage 191. In the second passage 191, the first passage 43, the passage in the notch 81, the passage in the groove part 30, the passage in the passage groove 158, and the first chamber 181 are in constant communication with the upper chamber 19. In the second passage 191, the passage part 185 and the second chamber 182 communicate with the lower chamber 20. The second passage 191 is a passage through which the oil fluid L moves from the upper chamber 19 on the upstream side toward the lower chamber 20 on the downstream side during the extension stroke. The second passage 191 is a passage through which the oil fluid L moves from the lower chamber 20 on the upstream side to the upper chamber 19 on the downstream side during the compression stroke. In the frequency sensitive mechanism 130, the partition member 133 is provided in the second passage 191. The partition member 133 partitions the second passage 191 between the first chamber 181 and the second chamber 182.

The second passage 191 shares the passages inside the passage hole 37 and the passage groove 38 of the piston 18 with the first passage 43. In the second passage 191, the passage in the notch 81, the passage in the groove part 30, the passage in the passage groove 158, the first chamber 181, the second chamber 182, and the passage part 185 are provided in parallel with a passage of the first passage 43 between the damping valve 91 and the valve seat part 48, between the upper chamber 19 and the lower chamber 20. The second passage 191 is provided in parallel with the first passage 44 between the lower chamber 20 and the upper chamber 19. Therefore, the second passage 191 is formed in parallel with the first passages 43 and 44, and is provided to allow the oil fluid L from both the upper chamber 19 and the lower chamber 20 to flow in due to the movement of the piston 18. Further, the second passage 191 may be provided to allow the oil fluid L from only one of the upper chamber 19 and the lower chamber 20 to flow in. That is, the second passage 191 may be provided to allow the oil fluid L from at least one of the upper chamber 19 and the lower chamber 20 to flow in.

The pressure chamber 187 shown in FIG. 4 is formed when the valve closing part 167 and the valve seat member 142 in the second passage 191 come into contact with each other due to the displacement of the partition member 133. The valve closing part 167 is provided in the partition member 133, and is formed of an elastic member that deforms to come into contact with the valve seat member 142 of the second passage 191 after the displacement of the partition member 133 and allow the partition member 133 to be displaceable even after the contact.

In the partition member 133, the first support part 178 on the inner circumferential side of the valve disc 161 is displaceable to the bottom part 150 side in the axial direction between the case member 131 and the support member 141. In a state in which the first support part 178 of the valve disc 161 is in contact with the support member 141 over the entire circumference as shown in FIGS. 3 and 4, the partition member 133 blocks a flow of the oil fluid L between the first chamber 181 and the second chamber 182. Also, in a state in which the first support part 178 of the valve disc 161 is separated from the support member 141 in the axial direction, the partition member 133 allows a flow of the oil fluid L between the second chamber 182 and the first chamber 181. The first support part 178 of the valve disc 161 and the support member 141 constitute a check valve 193. The check valve 193 is provided in the second passage 191.

The check valve 193 restricts a flow of the oil fluid L from the first chamber 181 to the second chamber 182 through the second passage 191, and allows a flow of the oil fluid L from the second chamber 182 to the first chamber 181 the second passage 191. The check valve 193 blocks communication between the upper chamber 19 and the lower chamber 20 through the second passage 191 during the extension stroke in which a pressure in the upper chamber 19 is higher than a pressure in the lower chamber 20. The check valve 193 allows communication between the lower chamber 20 and the upper chamber 19 through the second passage 191 during the compression stroke in which a pressure in the lower chamber 20 is higher than a pressure in the upper chamber 19. In this way, the second passage 191 allows communication between the lower chamber 20 and the upper chamber 19 when the check valve 193 opens.

On the piston rod 21, as shown in FIG. 2, the annular member 115, the disc 114, the disc 113, the plurality of discs 112, the disc 111, the piston 18, the plurality of discs 50, the plurality of discs 51, the pilot disc 52, the disc 53, the pilot case 55, the disc 56, the plurality of discs 57, the disc 58, and the disc 59 are stacked in that order on the shaft step part 29 with the mounting shaft part 28 inserted through the inside of them. At that time, in the pilot case 55, the seal member 86 of the pilot disc 52 is fitted into the outer cylindrical part 73.

From this state, as shown in FIG. 3, the case member 131 is stacked on the disc 59 with the mounting shaft part 28 inserted through the inside.

From this state, the plurality of discs 132 are stacked on the disc 59 with the mounting shaft part 28 inserted through the inside of them. At the same time, the partition member 133 is stacked on the seat part 154 of the case member 131 at the valve disc 161 such that the mounting shaft part 28 and the plurality of discs 132 are inserted through the inside. At this time, the elastic seal member 162 of the partition member 133 is fitted into the cylindrical part 153 of the case member 131.

Further, the plurality of discs 135, the plurality of discs 136, the plurality of discs 137, and the annular member 138 are stacked in that order on the disc 132 and the valve disc 161 of the partition member 133 with the mounting shaft part 28 inserted through the inside of them.

As shown in FIG. 2, with the parts from the annular member 115 to the annular member 138 disposed on the piston rod 21 as described above, a nut 195 is screwed onto the screw part 31 of the mounting shaft part 28 that protrudes from the annular member 138. Thereby, the parts from the annular member 115 to the annular member 138 are clamped in the axial direction by the shaft step part 29 of the piston rod 21 and the nut 195 at the inner circumferential side of them or in their entirety. At that time, the partition member 133, also including the inner circumferential side, is not clamped in the axial direction. In this state, in the partition member 133, as shown in FIG. 3, the first support part 178 of the valve disc 161 is in contact with the support member 141, the second support part 179 is in contact with the seat part 154 of the case member 131, and the contact part 166 of the elastic seal member 162 is in contact with the cover member 143.

As shown in FIG. 1, the base valve 25 described above is provided between the bottom part 12 of the outer cylinder 4 and the inner cylinder 3. The base valve 25 includes a base partition member 221, a disc valve 222, a disc valve 223, and an attachment pin 224. In the base valve 25, the base partition member 221 is placed on the bottom part 12, and the base partition member 221 is fitted in the inner cylinder 3. The base partition member 221 partitions the lower chamber 20 and the reservoir chamber 6. The disc valve 222 is provided on a lower side of the base partition member 221, that is, on the reservoir chamber 6 side. The disc valve 223 is provided on an upper side of the base partition member 221, that is, on the lower chamber 20 side. The attachment pin 224 attaches the disc valve 222 and the disc valve 223 to the base partition member 221.

The base partition member 221 has an annular shape, and the attachment pin 224 is inserted through a center thereof in the radial direction. A plurality of passage holes 225 and a plurality of passage holes 226 are formed in the base partition member 221. The plurality of passage holes 225 allow the oil fluid L to flow between the lower chamber 20 and the reservoir chamber 6. The plurality of passage holes 226 are disposed on an outer side of the plurality of passage holes 225 in a radial direction of the base partition member 221. The plurality of passage holes 226 allow the oil fluid L to flow between the lower chamber 20 and the reservoir chamber 6. The disc valve 222 on the reservoir chamber 6 side allows the oil fluid L to flow from the lower chamber 20 to the reservoir chamber 6 through the passage holes 225. On the other hand, the disc valve 222 suppresses a flow of the oil fluid L from the reservoir chamber 6 to the lower chamber 20 through the passage holes 225. The disc valve 223 allows the oil fluid L to flow from the reservoir chamber 6 to the lower chamber 20 through the passage holes 226. On the other hand, the disc valve 223 suppresses a flow of the oil fluid L from the lower chamber 20 to the reservoir chamber 6 through the passage holes 226.

The disc valve 222, together with the base partition member 221, constitutes a damping valve mechanism 227. The damping valve mechanism 227 opens during the compression stroke of the shock absorber 1 to allow the oil fluid L to flow from the lower chamber 20 to the reservoir chamber 6 and generate a damping force. The disc valve 223, together with the base partition member 221, constitutes a suction valve mechanism 228. The suction valve mechanism 228 opens during the extension stroke of the shock absorber 1 to allow the oil fluid L to flow from the reservoir chamber 6 to the lower chamber 20. Further, the suction valve mechanism 228 performs a function of causing the oil fluid L to flow from the reservoir chamber 6 to the lower chamber 20 substantially without generating a damping force so that a shortage of the fluid caused mainly due to extension of the piston rod 21 from the cylinder 2 is supplemented.

Next, main operations of the shock absorber 1 will be described.

“In case of assuming that frequency sensitive mechanism 130 does not act, and only damping force mechanism 41 and damping force mechanism 110 on extension side act during extension stroke”

In this case, when a moving speed of the piston 18 (hereinafter referred to as a piston speed) is lower than a first predetermined value, the oil fluid L from the upper chamber 19 flows into the lower chamber 20 through the first passage 43 and the fixed orifice 92 of the damping force mechanism 41 shown in FIG. 2. Therefore, a damping force having orifice characteristics (in which the damping force is substantially proportional to the square of the piston speed) is generated. Therefore, the damping force characteristics with respect to the piston speed when the piston speed is lower than the first predetermined value are such that an increasing rate of the damping force with respect to an increase in the piston speed is relatively high.

When the piston speed is equal to or higher than the first predetermined value and lower than a second predetermined value, the oil fluid L from the upper chamber 19 passes through the first passage 43, the passage in the notch 81, the passage in the groove part 30, the passage in the passage groove 79, and the back pressure chamber 100 to flow into the lower chamber 20 through between the disc valve 99 and the valve seat part 75 while opening the disc valve 99 of the damping force mechanism 110. Therefore, a damping force having valve characteristics (in which the damping force is substantially proportional to the piston speed) is generated. Therefore, the damping force characteristics with respect to the piston speed when the piston speed is equal to or higher than the first predetermined value and lower than the second predetermined value are such that the increasing rate of the damping force with respect to the increase in the piston speed is lower than that when the piston speed is lower than the first predetermined value.

When the piston speed increases to the second predetermined value or higher, a relationship of a force (hydraulic pressure) acting on the damping valve 91 of the damping force mechanism 41 is such that a force in an opening direction exerted from the first passage 43 becomes larger than a force in a closing direction exerted from the back pressure chamber 100. Therefore, in this region, as the piston speed increases, the damping valve 91 is separated from the valve seat part 48 of the piston 18 and opens. Therefore, the oil fluid L from the upper chamber 19 flows from the first passage 43 to the lower chamber 20 through between the damping valve 91 and the valve seat part 48 while opening the damping valve 91 in addition to a flow to the lower chamber 20 through between the disc valve 99 and the valve seat part 75 while opening the disc valve 99 described above. Therefore, the increasing rate of the damping force with respect to the increase in the piston speed when the piston speed is equal to or higher than the second predetermined value is lower than that when the piston speed is equal to or higher than the first predetermined value and lower than the second predetermined value.

“In case of assuming that frequency sensitive mechanism 130 does not act, and only damping force mechanism 42 on compression side acts during compression stroke”

In this case, when the piston speed is lower than a third predetermined value, the oil fluid L from the lower chamber 20 flows into the upper chamber 19 via the first passage 44 and the fixed orifice 123 of the damping force mechanism 42. Thereby, a damping force having orifice characteristics is generated. Therefore, the damping force characteristics with respect to the piston speed when the piston speed is lower than the third predetermined value are such that the increasing rate of the damping force with respect to the increase in the piston speed is relatively high.

When the piston speed increases to the third predetermined value or higher, the oil fluid L introduced from the lower chamber 20 into the first passage 44 flows into the upper chamber 19 through between the disc valve 122 and the valve seat part 49 while opening the disc valve 122 of the damping force mechanism 42. Thereby, a damping force having valve characteristics is generated. Therefore, the damping force characteristics with respect to the piston speed when the piston speed is equal to or higher than the third predetermined value are such that the increasing rate of the damping force with respect to the increase in the piston speed is lower than that when the piston speed is lower than the third predetermined value.

“In case in which frequency sensitive mechanism 130 acts during extension stroke”

In the first embodiment, the frequency sensitive mechanism 130 varies the damping force according to the piston frequency even when the piston speed is the same. The frequency sensitive mechanism 130 is a flow rate variable mechanism that varies a flow rate of the oil fluid flowing through the damping force mechanisms 41 and 110 according to the piston frequency even when the piston speed is the same.

In the extension stroke, the oil fluid is introduced from the upper chamber 19 into the first chamber 181 of the frequency sensitive mechanism 130 via the first passage 43, the passage in the notch 81, the passage in the groove part 30, and the passage in the passage groove 158 shown in FIG. 3. Therefore, the valve disc 161 of the partition member 133 that has been in contact with the seat part 154 and the support member 141 deforms, due to a pressure load, in a tapered shape in a direction in which the outer circumferential side thereof is separated from the seat part 154 using the contact point with the support member 141 as a fulcrum. At that time, the valve disc 161 compressively deforms mainly the distal end portion 171 of the contact part 166 that is in contact with the cover member 143.

Here, in the extension stroke when the piston frequency is high, a stroke of the piston 18 is small. Therefore, an amount of the oil fluid L introduced from the upper chamber 19 shown in FIG. 2 into the first chamber 181 via the first passage 43, the passage in the notch 81, the passage in the groove part 30, and the passage in the passage groove 158 is small. Therefore, although the partition member 133 deforms as described above due to the pressure load, an amount of deformation is small. Therefore, during the extension stroke when the piston frequency is high, the partition member 133 of the frequency sensitive mechanism 130 deforms as described above in each extension stroke, and thereby the oil fluid L from the upper chamber 19 is introduced into the first chamber 181. Then, a flow rate of the oil fluid L flowing from the upper chamber 19 to the lower chamber 20 through the first passage 43, the passage in the notch 81, the passage in the groove part 30, the passage in the passage groove 158, and the back pressure chamber 100 while opening the damping force mechanism 110 is reduced. Also, in addition to this, a flow rate of the oil fluid L flowing from the first passage 43 into the lower chamber 20 while opening the damping force mechanism 41 is also reduced. In addition, when the oil fluid L is introduced from the upper chamber 19 into the first chamber 181, an increase in pressure of the back pressure chamber 100 is suppressed compared to a case without the first chamber 181, and the damping valve 91 of the damping force mechanism 41 becomes easier to open. Thereby, the extension-side damping force becomes softer.

During the extension stroke when the piston frequency is high, the amount of deformation of the partition member 133 is small as described above. In other words, during the extension stroke when the piston frequency is high, a pressure difference between the first chamber 181 and the second chamber 182 with respect to the partition member 133 is small. That is, the displacement of the partition member 133 to the cover member 143 side becomes a first displacement in which an amount of displacement is equal to or less than a predetermined value, and the valve closing part 167 shown in FIG. 3 does not close the flow path between itself and the valve seat member 142, or even if it does close it, the pressure difference between the first chamber 181 and the second chamber 182 with respect to the partition member 133 does not become excessive. In a state in which the valve closing part 167 does not close the flow path between itself and the valve seat member 142, the partition member 133 is easily displaced by discharging the entire oil fluid L in the second chamber 182 of the frequency sensitive mechanism 130 into the lower chamber 20 through the passage part 185.

On the other hand, during the extension stroke when the piston frequency is low, the stroke of the piston 18 is large. Therefore, an amount of the oil fluid L introduced from the upper chamber 19 shown in FIG. 2 into the first chamber 181 via the first passage 43, the passage in the notch 81, the passage in the groove part 30, and the passage in the passage groove 158 is large. Therefore, although the oil fluid L flows from the upper chamber 19 to the first chamber 181 at the beginning of the stroke of the piston 18, thereafter the partition member 133 deforms to near the limit and does not deform more than that. As a result, the oil fluid L does not flow from the upper chamber 19 to the first chamber 181. Thereby, the flow rate of the oil fluid L flowing from the upper chamber 19 to the lower chamber 20 through the first passage 43, the passage in the notch 81, the passage in the groove part 30, the passage in the passage groove 158, and the back pressure chamber 100 while opening the damping force mechanism 110 is not reduced. Also, in addition to this, the flow rate of the oil fluid L flowing from the first passage 43 into the lower chamber 20 while opening the damping force mechanism 41 is neither reduced. In addition, the oil fluid L is not introduced into the first chamber 181 from the upper chamber 19, and thereby the pressure in the back pressure chamber 100 increases, making it difficult for the damping valve 91 of the damping force mechanism 41 to open. Thereby, the extension-side damping force becomes harder than when the frequency is high.

Here, at the beginning of the extension stroke when the piston frequency is low, and when the displacement of the partition member 133 to the cover member 143 side is the first displacement in which an amount of displacement is equal to or less than the predetermined value, the valve closing part 167 shown in FIG. 3 does not come into contact with the valve seat member 142, or it does not close the flow path between itself and the valve seat member 142 even if it does come into contact with the valve seat member 142. Therefore, the partition member 133 is easily displaced by discharging the entire oil fluid L in the second chamber 182 of the frequency sensitive mechanism 130 into the lower chamber 20 through the passage part 185.

On the other hand, after the above-described initial stage of the extension stroke when the piston frequency is low, the pressure difference between the first chamber 181 and the second chamber 182 becomes large, the pressure load on the partition member 133 increases, and the displacement of the partition member 133 to the cover member 143 side becomes a second displacement in which an amount of displacement exceeds the predetermined value. Then, as shown in FIG. 4, the valve closing part 167 comes into contact with the valve seat member 142 over the entire circumference, and closes the flow path between itself and the valve seat member 142. In this state, a radially inner side of the valve closing part 167 in the second chamber 182 becomes the sealed pressure chamber 187, and the oil fluid L inside the pressure chamber 187 is not discharged to the communication chamber 188. In a state in which the pressure chamber 187 closed as described above is formed, a pressure in the pressure chamber 187 also increases according to an increase in pressure of the first chamber 181. Therefore, in the partition member 133, an increase in pressure difference between the first chamber 181 side at a radially inner portion from the valve closing part 167 and the second chamber 182 side is suppressed. Therefore, in the partition member 133, an increase in stress on the first support part 178 side, particularly when deformation of the valve disc 161 on the first support part 178 side that is in contact with the support member 141 becomes large, is suppressed.

During the compression stroke, the pressure in the lower chamber 20 increases, but the valve disc 161 of the partition member 133 of the frequency sensitive mechanism 130 comes into contact with the seat part 154 of the case member 131 at the second support part 179 to suppress extension of the second chamber 182. Therefore, an amount of the oil fluid L introduced into the second chamber 182 from the lower chamber 20 through the passage part 185 is suppressed. As a result, it becomes a state in which a flow rate of the oil fluid L introduced from the lower chamber 20 into the first passage 44 shown in FIG. 2, passing through the damping force mechanism 42, and flowing into the upper chamber 19 is not reduced. During the compression stroke, when the piston speed increases and a pressure in the second chamber 182 becomes higher than a pressure in the first chamber 181 by a predetermined value or more, the first support part 178 of the valve disc 161 of the partition member 133 separates from the support member 141. In other words, the check valve 193 opens. Thereby, the oil fluid L flows from the lower chamber 20 to the upper chamber 19 via the passage part 185, the second chamber 182, the check valve 193, the first chamber 181, the passage in the passage groove 158, the passage in the groove part 30, the passage in the notch 81, and the first passage 43. As described above, the partition member 133 reduces a differential pressure between the second chamber 182 side and the first chamber 181 side when the check valve 193 opens. Therefore, excessive bending of the partition member 133 is suppressed.

The above-described Patent Document 1 discloses a shock absorber in which damping force characteristics can be varied according to a vibration state. Incidentally, in a shock absorber in which damping force characteristics can be varied according to a vibration state, a partition member that displaces while partitioning a passage may be used, and it is desirable to enhance durability of the partition member.

In the shock absorber 1 of the first embodiment, the second passage 191 provided to allow the oil fluid L from at least one of the upper chamber 19 and the lower chamber 20 to flow in due to movement of the piston 18 is provided in parallel with the first passage 43 in which the first damping force mechanism 41 that generates a damping force is provided. The shock absorber 1 is provided with the frequency sensitive mechanism 130 that varies the damping force in the second passage 191. Then, the frequency sensitive mechanism 130 includes the partition member 133 partitioning the second passage 191, displaced by the oil fluid L that has flowed in due to movement of the piston 18, and discharging at least some of the oil fluid L in the second passage 191 into the cylinder 2. Also, the frequency sensitive mechanism 130 includes the valve closing part 167 forming the pressure chamber 187 closed between the valve seat member 142 in the second passage 191 and the partition member 133 to limit movement of the oil fluid L in the pressure chamber 187. In other words, in the shock absorber 1, the valve closing part 167 forms the pressure chamber 187 closed between the inside of the second passage 191 and the partition member 133.

Therefore, in the shock absorber 1, when the pressure in the first chamber 181 on a side of the partition member 133 opposite to the pressure chamber 187 in the second passage 191 increases, the pressure inside the pressure chamber 187 also increases accordingly, thereby suppressing the displacement of the partition member 133. In this way, since the shock absorber 1 can suppress the displacement of the partition member 133, durability of the partition member 133 can be enhanced. Also, since the shock absorber 1 suppresses the displacement of the partition member 133 by the pressure of the oil fluid L, it is possible to suppress occurrence of abnormal noise that is likely to occur when metal parts are used for the suppression. Also, when the displacement of the partition member 133 is suppressed, since the shock absorber 1 can gently suppress the displacement by the pressure of the oil fluid L, it is possible to suppress a decrease in ride comfort that occurs due to a sudden change in damping force.

Also, in the shock absorber 1, the pressure chamber 187 is formed when the valve seat member 142 in the second passage 191 and the valve closing part 167 come into contact with each other due to the displacement of the partition member 133. In the shock absorber 1, the pressure chamber 187 can be formed by the displacement of the partition member 133 as described above. Therefore, the shock absorber 1, by using the displacement of the partition member 133, can vary the damping force by easily displacing the partition member 133 without forming the pressure chamber 187, or can suppress the displacement of the partition member 133 by forming the pressure chamber 187.

Also, in the shock absorber 1, the valve closing part 167 is provided in the partition member 133 and is formed of an elastic member that deforms to come into contact with the valve seat member 142 of the second passage 191 after the displacement of the partition member 133 and allow the partition member 133 to be displaceable even after the contact. In the shock absorber 1, since the valve closing part 167 is provided in the partition member 133, the pressure chamber 187 can be easily formed by the displacement of the partition member 133.

Also, in the shock absorber 1, since the valve closing part 167 deforms to allow the partition member 133 to be displaceable even after coming into contact with the valve seat member 142, the shock absorber 1 can more gently suppress the displacement of the partition member 133 at the time of suppressing the displacement. Therefore, the shock absorber 1 can further suppress occurrence of abnormal noise, and can further suppress a decrease in ride comfort caused by a sudden change in damping force.

### Second Embodiment

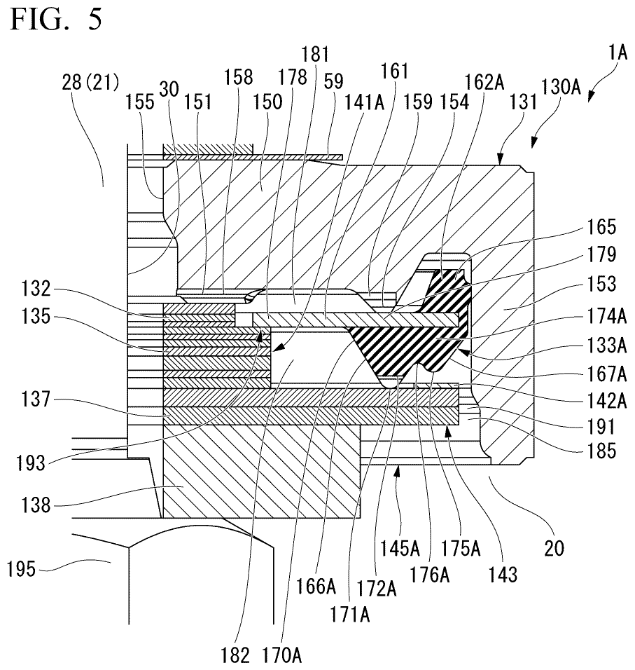

Next, a second embodiment will be described mainly on the basis of FIG. 5, focusing on differences from the first embodiment. Also, parts common to those in the first embodiment will be denoted by the same terms and the same reference signs.

As shown in FIG. 5, a shock absorber 1A of the second embodiment includes a frequency sensitive mechanism 130A (second damping force mechanism), which is partially different from the frequency sensitive mechanism 130, instead of the frequency sensitive mechanism 130.

The frequency sensitive mechanism 130A includes a partition member 133A, which is partially different from the partition member 133, instead of the partition member 133. The partition member 133A includes an elastic seal member 162A, which is partially different from the elastic seal member 162, instead of the elastic seal member 162. The elastic seal member 162A includes a contact part 166A, which is partially different from the contact part 166, instead of the contact part 166. The elastic seal member 162A includes a valve closing part 167A, which is partially different from the valve closing part 167, instead of the valve closing part 167.

The contact part 166A has an annular shape, and a base end portion 170A on a valve disc 161 side in an axial direction of the partition member 133A is fixed to an outer circumferential side of the valve disc 161 by baking.

An inner circumferential portion of the contact part 166A has an inner diameter that increases with distance away from the valve disc 161 in the axial direction of the partition member 133A. An outer circumferential portion of a distal end portion 171A on a protruding side of the contact part 166A has an outer diameter that decreases with distance away from the valve disc 161 in the axial direction of the partition member 133A. Therefore, a cross-sectional shape of the distal end portion 171A of the contact part 166A in a plane including a central axis of the partition member 133A is a tapered single-chevron shape that becomes thinner with distance away from the valve disc 161 in the axial direction of the partition member 133A.

A notch part 172A penetrating the distal end portion 171A in a radial direction of the partition member 133A is formed in the distal end portion 171A of the contact part 166A. A plurality of notch parts 172A are formed in the contact part 166A at intervals in a circumferential direction of the partition member 133A. Therefore, the distal end portion 171A of the contact part 166A is intermittently cut out in the circumferential direction of the partition member 133A.

The valve closing part 167A has an annular shape, and is provided on an outer side of the contact part 166A in the radial direction of the partition member 133A. The valve closing part 167A has a base end portion 174A provided on the valve disc 161 side in the axial direction of the partition member 133A and fixed to an outer circumferential edge portion of the valve disc 161 in the radial direction by baking. A seal part 165 and the base end portion 174A of the valve closing part 167A are connected and integrated on the outer circumferential side of the valve disc 161. The base end portion 174A of the valve closing part 167A is connected to and integrated with the base end portion 170A of the contact part 166A.

An outer circumferential portion of the valve closing part 167A has an outer diameter that decreases with distance away from the valve disc 161 in the axial direction of the partition member 133A. An inner circumferential portion of a distal end portion 175A on a protruding side of the valve closing part 167A has an outer diameter that decreases with distance away from the valve disc 161 in the axial direction of the partition member 133A. Therefore, a cross-sectional shape of the distal end portion 175A of the valve closing part 167A in a plane including a central axis of the partition member 133A is a tapered single-chevron shape that becomes thinner with distance away from the valve disc 161 in the axial direction of the partition member 133A. Therefore, the partition member 133A has a double-chevron shape formed of the distal end portion 171A of the contact part 166A and the distal end portion 175A of the valve closing part 167A. A cross-sectional shape of the distal end portion 175A of the valve closing part 167A in a plane including the central axis of the partition member 133A is consistent over the entire circumference. A protrusion height of the valve closing part 167A from the valve disc 161 is smaller than a protrusion height of the contact part 166A from the valve disc 161.

The elastic seal member 162A has a recessed part 176A between the contact part 166A and the valve closing part 167A in the radial direction of the partition member 133A. The recessed part 176A is recessed from the distal end portion 171A of the contact part 166A and the distal end portion 175A of the valve closing part 167A to the valve disc 161 side in the axial direction of the partition member 133A. The recessed part 176A has an annular shape that is continuous over the entire circumference of the partition member 133A.

The frequency sensitive mechanism 130A includes a valve case 145A, which is partially different from the valve case 145, instead of the valve case 145. The valve case 145A includes a support member 141A, which is partially different from the support member 141, instead of the support member 141. The number of discs 135 in the support member 141A is different from that in the support member 141. The support member 141A is constituted by a plurality of (specifically, seven) discs 135 having the same outer diameter and the same inner diameter. The plurality of discs 136 constituting the valve seat member 142 is not provided in the valve case 145A. Instead of the discs 136, the number of discs 135 constituting the support member 141A is increased compared to the support member 141. The support member 141A has a lager thickness in the axial direction than the support member 141.

The valve case 145A includes a valve seat member 142A provided on an outer circumferential edge portion of the cover member 143 on the support member 141A side in the axial direction. The valve seat member 142A has a perforated disc shape having a constant outer diameter over the entire circumference and a constant radial width over the entire circumference. The valve seat member 142A is disposed on an outer circumferential edge portion of a disc 137, which is at an end portion of discs 137 constituting the cover member 143 on the support member 141A side in the axial direction, to be coaxial with the disc 137 and is fixed by adhesion or the like. In the partition member 133A, the contact part 166A and the valve closing part 167A are disposed on a side of the partition member 133A opposite to the bottom part 150 in the axial direction. The contact part 166A is in contact with the cover member 143 formed of a plurality of discs 137 at the distal end portion 171A. The contact part 166A biases a second support part 179 side of the valve disc 161 in the radial direction to a seat part 154 side in the axial direction of the valve disc 161.

In the partition member 133A, the valve closing part 167A is disposed on a side of the partition member 133A opposite to the bottom part 150 in the axial direction. The distal end portion 175A of the valve closing part 167A overlaps the valve seat member 142A in position in the radial direction of the partition member 133A. In the partition member 133A, when the valve disc 161 deforms in the axial direction of the partition member 133A, the valve closing part 167A is displaced with respect to the valve seat member 142A, and thereby the distal end portion 175A of the valve closing part 167A is separated from and seated on the valve seat member 142A. Further, the partition member 133A is not limited to being displaced in the axial direction by deformation, and may also be displaced in the axial direction by movement.

The valve disc 161 of the partition member 133A is bendable in a tapered shape such that the second support part 179 is separated from the seat part 154 while a first support part 178 remains in contact with the support member 141. When bending in this manner, the valve disc 161 elastically deforms the contact part 166A in contact with the cover member 143. Then, when the valve disc 161 bends by a predetermined amount, the distal end portion 175A of the valve closing part 167A is brought into contact with the valve seat member 142A.

The partition member 133A is provided inside the valve case 145A and partitions the inside of the valve case 145A into a first chamber 181 and a second chamber 182. The first chamber 181 is provided between the bottom part 150 and the partition member 133A in an axial direction of the valve case 145A. The second chamber 182 is provided between the partition member 133A and the cover member 143 in the axial direction of the valve case 145A.

As shown in FIG. 5, in a state in which the valve closing part 167A of the partition member 133A is separated from the valve seat member 142A, the entire second chamber 182 communicates with a lower chamber 20 through a passage part 185 between the cover member 143 and a cylindrical part 153 of a case member 131.

In a state in which the partition member 133A is deformed into a tapered shape and the valve closing part 167A is in contact with the valve seat member 142A over the entire circumference, the second chamber 182 is partitioned into a pressure chamber on a radially inner side of the valve closing part 167A and a communication chamber on a radially outer side of the valve closing part 167A. The communication chamber communicates with the lower chamber 20 through the passage part 185. The pressure chamber does not communicate with the communication chamber, and therefore neither communicates with the lower chamber 20.

During an extension stroke, an oil fluid L from an upper chamber 19 (see FIG. 2) is introduced into the first chamber 181 via a first passage 43 (see FIG. 2), a passage in a notch 81 (see FIG. 2) of a disc 50 (see FIG. 2), a passage in a groove part 30 of a piston rod 21 shown in FIG. 5, and a passage in a passage groove 158 of the case member 131. Then, the valve disc 161 of the partition member 133A bends in a tapered shape so that the second support part 179 is separated from the bottom part 150 further than the first support part 178 in the axial direction of the case member 131 using a contact point with the support member 141 that is in contact at the first support part 178 as a fulcrum. At that time, the valve disc 161 compressively deforms the contact part 166A that comes into contact with the cover member 143 in the axial direction of the case member 131.

Due to the displacement as described above, the partition member 133A increases a volume of the first chamber 181. Here, during this displacement of the partition member 133A, a volume of the second chamber 182 decreases. At that time, the oil fluid L in the second chamber 182 flows into the lower chamber 20 through the passage part 185.

Here, during the extension stroke, in a state in which the displacement of the partition member 133A is smaller than a predetermined amount, the valve closing part 167A is separated from the valve seat member 142A, and therefore the oil fluid L flows from the entire second chamber 182 to the lower chamber 20 through the passage part 185.

On the other hand, during the extension stroke, in a state in which the displacement of the partition member 133A is equal to or larger than the predetermined amount, the valve closing part 167A comes into contact with the valve seat member 142A over the entire circumference, and partitions the second chamber 182 into the pressure chamber on a radially inner side of the valve closing part 167A and the communication chamber on a radially outer side of the valve closing part 167A. The second chamber 182 is placed in a state in which the communication chamber communicates with the lower chamber 20 through the passage part 185, but the pressure chamber does not communicate with the lower chamber 20.

That is, in the frequency sensitive mechanism 130A, the partition member 133A is displaced by the oil fluid L that has flowed into the first chamber 181 due to movement of a piston 18 (see FIG. 2) during the extension stroke, and discharges at least some of the oil fluid L in the second chamber 182 constituting a second passage 191 into the lower chamber 20 in a cylinder 2 (see FIG. 2). Also, in the frequency sensitive mechanism 130A, the valve closing part 167A forms the pressure chamber closed between the cover member 143 and the valve seat member 142A in the second passage 191 and the partition member 133A, thereby restricting movement of the oil fluid L in the pressure chamber. The pressure chamber is formed when the valve closing part 167A and the valve seat member 142A in the second passage 191 come into contact with each other due to the displacement of the partition member 133A. The valve closing part 167A is provided in the partition member 133A, and is formed of an elastic member that deforms to come into contact with the valve seat member 142A of the second passage 191 after the displacement of the partition member 133A and allow the partition member 133A to be displaceable even after the contact. In the frequency sensitive mechanism 130A, the partition member 133A is provided in the second passage 191. The partition member 133A partitions the second passage 191 between the first chamber 181 and the second chamber 182.

The shock absorber 1A varies the damping force according to a piston frequency similarly to the shock absorber 1.

In the shock absorber 1A of the second embodiment, the frequency sensitive mechanism 130A provided at the second passage 191 to vary the damping force includes the valve closing part 167A that forms the pressure chamber closed between the cover member 143 and the valve seat member 142A in the second passage 191 and the partition member 133A to restrict movement of the oil fluid L in the pressure chamber. In the shock absorber 1A, when the valve closing part 167A forms the pressure chamber closed between the inside of the second passage 191 and the partition member 133A, if a pressure in the first chamber 181 on a side of the partition member 133A opposite to the pressure chamber in the second passage 191 increases, a pressure inside the pressure chamber also increases accordingly, thereby suppressing the displacement of the partition member 133A. In this way, since the shock absorber 1A can suppress the displacement of the partition member 133A, durability of the partition member 133A can be enhanced. Also, since the shock absorber 1A suppresses the displacement of the partition member 133A by the pressure of the oil fluid L, it is possible to suppress occurrence of abnormal noise. Also, since the shock absorber 1A can gently suppress the displacement of the partition member 133A by the pressure of the oil fluid L, it is possible to suppress a decrease in ride comfort that occurs due to a sudden change in damping force.

Also, in the shock absorber 1A, the pressure chamber is formed when the valve seat member 142A in the second passage 191 and the valve closing part 167A come into contact with each other due to the displacement of the partition member 133A. In the shock absorber 1A, the pressure chamber is formed by the displacement of the partition member 133A as described above. Therefore, the shock absorber 1A, by using the displacement of the partition member 133A, can vary the damping force by easily displacing the partition member 133A without forming the pressure chamber, or can suppress the displacement of the partition member 133A by forming the pressure chamber.

Also, in the shock absorber 1A, the valve closing part 167A is provided in the partition member 133A, and is formed of an elastic member that deforms to come into contact with the valve seat member 142A of the second passage 191 after the displacement of the partition member 133A and allow the partition member 133A to be displaceable even after the contact. Therefore, in the shock absorber 1A, the pressure chamber can be easily formed by the displacement of the partition member 133A, and the displacement of the partition member 133A can be more gently suppressed at the time of suppressing the displacement.

### Third Embodiment

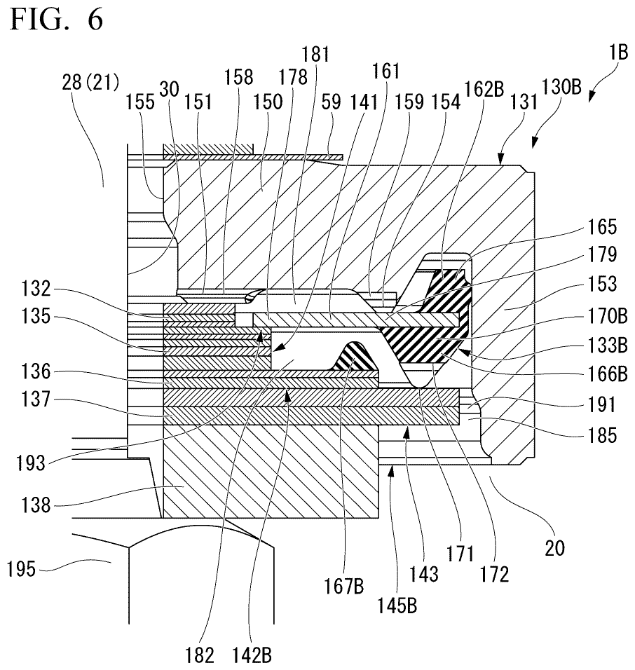

Next, a third embodiment will be described mainly on the basis of FIG. 6, focusing on differences from the first embodiment. Also, parts common to those in the first embodiment will be denoted by the same terms and the same reference signs.

As shown in FIG. 6, a shock absorber 1B of the third embodiment includes a frequency sensitive mechanism 130B (second damping force mechanism), which is partially different from the frequency sensitive mechanism 130, instead of the frequency sensitive mechanism 130.

The frequency sensitive mechanism 130B includes a partition member 133B, which is partially different from the partition member 133, instead of the partition member 133. The partition member 133B includes an elastic seal member 162B, which is partially different from the elastic seal member 162, instead of the elastic seal member 162. The elastic seal member 162B includes a contact part 166B, which is partially different from the contact part 166, instead of the contact part 166, and the valve closing part 167 is not provided.

The contact part 166B includes a base end portion 170B, which is partially different from the base end portion 170, instead of the base end portion 170. The contact part 166B has an annular shape, and the base end portion 170B on a valve disc 161 side in an axial direction of the partition member 133B is fixed to an outer circumferential side of the valve disc 161 by baking.

An inner circumferential portion of the contact part 166B has an inner diameter that increases with distance away from the valve disc 161 in the axial direction of the partition member 133B. An outer circumferential portion of the contact part 166B has an outer diameter that decreases with distance away from the valve disc 161 in the axial direction of the partition member 133B. Therefore, a cross-sectional shape of the contact part 166B in a plane including a central axis of the partition member 133B is a tapered single-chevron shape that becomes thinner with distance away from the valve disc 161 in the axial direction of the partition member 133B.

The frequency sensitive mechanism 130B includes a valve case 145B, which is partially different from the valve case 145, instead of the valve case 145. The valve case 145B includes a valve seat member 142B, which is partially different from the valve seat member 142, instead of the valve seat member 142. The valve seat member 142B includes a valve closing part 167B formed of an elastic seal material in addition to a plurality of (specifically, two) discs 136. The valve closing part 167B is made of rubber and has an annular shape. The valve closing part 167B is disposed on an outer circumferential edge portion of the disc 136, which is closest to a support member 141 side in the axial direction among the plurality of discs 136, to be coaxial with the disc 136, and is adhered by baking. The valve closing part 167B protrudes from the disc 136 to the support member 141 side in an axial direction of the disc 136.

An inner circumferential portion of the valve closing part 167B has an inner diameter that increases with distance away from the disc 136 in an axial direction of the valve seat member 142B. An outer circumferential portion of the valve closing part 167B has an outer diameter that decreases with distance away from the disc 136 in the axial direction of the valve seat member 142B. Therefore, a cross-sectional shape of the valve closing part 167B in a plane including a central axis of the valve seat member 142B is a tapered single-chevron shape that becomes thinner with distance away from the disc 136 in the axial direction of the valve seat member 142B. A cross-sectional shape of the valve closing part 167B in a plane including the central axis of the valve seat member 142B is consistent over the entire circumference.

In the partition member 133B, the contact part 166B is disposed on a side of the partition member 133B opposite to a bottom part 150 in the axial direction. The contact part 166B is in contact with the cover member 143 formed of a plurality of discs 137 at a distal end portion 171 thereof. The contact part 166B biases a second support part 179 side of the valve disc 161 in a radial direction to a seat part 154 side in an axial direction of the valve disc 161.

The valve closing part 167B of the valve seat member 142B is provided between the contact part 166B and the support member 141 in a radial direction of the valve seat member 142B.

In the partition member 133B, the partition member 133B is displaced with respect to the valve seat member 142B when the valve disc 161 deforms in the axial direction of the partition member 133B, and thereby the valve disc 161 is separated from and seated on the valve closing part 167B. Further, the partition member 133B is not limited to being displaced in the axial direction by deformation, and may also be displaced in the axial direction by movement.

The valve disc 161 of the partition member 133B is bendable in a tapered shape such that the second support part 179 is separated from the seat part 154 while a first support part 178 remains in contact with the support member 141. When bending in this manner, the valve disc 161 elastically deforms the contact part 166B in contact with the cover member 143. Then, when the valve disc 161 bends by a predetermined amount, it comes into contact with the valve closing part 167B of the valve seat member 142B.

The partition member 133B is provided in the valve case 145B and partitions the inside of the valve case 145B into a first chamber 181 and a second chamber 182. The first chamber 181 is provided between the bottom part 150 and the partition member 133B in an axial direction of the valve case 145B. The second chamber 182 is provided between the partition member 133B, and the valve seat member 142B and the cover member 143 in the axial direction of the valve case 145B.

As shown in FIG. 6, in a state in which the valve disc 161 of the partition member 133B is separated from the valve closing part 167B of the valve seat member 142B, the entire second chamber 182 communicates with a lower chamber 20 through a passage part 185 between the cover member 143 and the cylindrical part 153 of the case member 131.

In a state in which the partition member 133B is deformed into a tapered shape and the valve disc 161 is in contact with the valve closing part 167B of the valve seat member 142B over the entire circumference, the second chamber 182 is partitioned into a pressure chamber on a radially inner side of the valve closing part 167B and a communication chamber on a radially outer side of the valve closing part 167B. This communication chamber communicates with the lower chamber 20 through the passage part 185. The pressure chamber does not communicate with the communication chamber, and therefore neither communicates with the lower chamber 20.

During an extension stroke, an oil fluid L from an upper chamber 19 (see FIG. 2) is introduced into the first chamber 181 via a first passage 43 (see FIG. 2), a passage in a notch 81 (see FIG. 2) of a disc 50 (see FIG. 2), a passage in a groove part 30 of a piston rod 21 shown in FIG. 6, and a passage in a passage groove 158 of the case member 131. Then, the valve disc 161 of the partition member 133B bends in a tapered shape so that the second support part 179 is separated from the bottom part 150 further than the first support part 178 in the axial direction of the case member 131 using a contact point with the support member 141 that is in contact at the first support part 178 as a fulcrum. At that time, the valve disc 161 compressively deforms the contact part 166B that comes into contact with the cover member 143 in the axial direction of the case member 131.

Due to the displacement of the partition member 133B as described above, the partition member 133B increases a volume of the first chamber 181. Here, during this displacement of the partition member 133B, a volume of the second chamber 182 decreases. At that time, the oil fluid L in the second chamber 182 flows into the lower chamber 20 through the passage part 185.

Here, during the extension stroke, in a state in which the displacement of the partition member 133B is smaller than a predetermined amount, the valve disc 161 of the partition member 133B is separated from the valve closing part 167B of the valve seat member 142B, and therefore the oil fluid L flows from the entire second chamber 182 to the lower chamber 20 through the passage part 185.

On the other hand, during the extension stroke, in a state in which the displacement of the partition member 133B is equal to or larger than the predetermined amount, the valve disc 161 of the partition member 133B comes into contact with the valve closing part 167B of the valve seat member 142B over the entire circumference, and partitions the second chamber 182 into the pressure chamber on a radially inner side of the valve closing part 167B and the communication chamber on a radially outer side of the valve closing part 167B. The second chamber 182 is placed in a state in which the communication chamber communicates with the lower chamber 20 through the passage part 185, but the pressure chamber does not communicate with the lower chamber 20.

That is, in the frequency sensitive mechanism 130B, the partition member 133B is displaced by the oil fluid L that has flowed into the first chamber 181 due to movement of a piston 18 (see FIG. 2) during the extension stroke, and discharges at least some of the oil fluid L in the second chamber 182 constituting a second passage 191 into the lower chamber 20 in a cylinder 2 (see FIG. 2). Also, in the frequency sensitive mechanism 130B, the valve closing part 167B forms the pressure chamber that is closed between the valve seat member 142B in the second passage 191 and the partition member 133B, thereby restricting movement of the oil fluid L in the pressure chamber. The pressure chamber is formed when the partition member 133B and the valve closing part 167B of the valve seat member 142B in the second passage 191 come into contact with each other due to the displacement of the partition member 133B. The valve closing part 167B is provided on the valve seat member 142B in the second passage 191, and is formed of an elastic member that deforms to come into contact with the partition member 133B after the displacement of the partition member 133B and allow the partition member 133B to be displaceable even after the contact. In the frequency sensitive mechanism 130B, the partition member 133B is provided in the second passage 191. The partition member 133B partitions the second passage 191 between the first chamber 181 and the second chamber 182.

The shock absorber 1B varies the damping force according to a piston frequency similarly to the shock absorber 1.

In the shock absorber 1B of the third embodiment, the frequency sensitive mechanism 130B provided at the second passage 191 to vary the damping force includes the valve closing part 167B that forms the pressure chamber closed between the valve seat member 142B in the second passage 191 and the partition member 133B to restrict movement of the oil fluid L in the pressure chamber. In the shock absorber 1B, when the valve closing part 167B forms the pressure chamber closed between the inside of the second passage 191 and the partition member 133B, if a pressure in the first chamber 181 on a side of the partition member 133B opposite to the pressure chamber in the second passage 191 increases, a pressure inside the pressure chamber also increases accordingly, thereby suppressing the displacement of the partition member 133B. In this way, since the shock absorber 1B can suppress the displacement of the partition member 133B, durability of the partition member 133B can be enhanced. Also, since the shock absorber 1B suppresses the displacement of the partition member 133B by the pressure of the oil fluid L, it is possible to suppress occurrence of abnormal noise. Also, since the shock absorber 1B can gently suppress the displacement of the partition member 133B by the pressure of the oil fluid L, it is possible to suppress a decrease in ride comfort that occurs due to a sudden change in damping force.

Also, in the shock absorber 1B, the pressure chamber is formed when the partition member 133B and the valve closing part 167B in the second passage 191 come into contact with each other due to the displacement of the partition member 133B. In the shock absorber 1B, the pressure chamber is formed by the displacement of the partition member 133B as described above. Therefore, the shock absorber 1B, by using the displacement of the partition member 133B, can vary the damping force by easily displacing the partition member 133B without forming the pressure chamber, or can suppress the displacement of the partition member 133B by forming the pressure chamber.

Also, in the shock absorber 1B, the valve closing part 167B is provided on the valve seat member 142B which is a part of the second passage 191, and is formed of an elastic member that deforms to come into contact with the partition member 133B after the displacement of the partition member 133B and allow the partition member 133B to be displaceable even after the contact. Therefore, the shock absorber 1B can more gently suppress the displacement of the partition member 133B at the time of suppressing the displacement.

### Fourth Embodiment

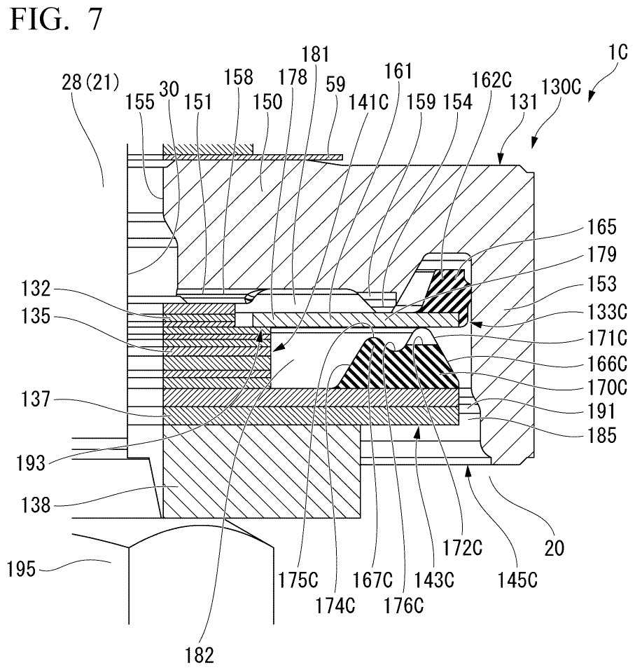

Next, a fourth embodiment will be described mainly on the basis of FIG. 7 focusing on differences from the first embodiment. Also, parts common to those in the first embodiment will be denoted by the same terms and the same reference signs.

As shown in FIG. 7, a shock absorber 1C of the fourth embodiment includes a frequency sensitive mechanism 130C (second damping force mechanism), which is partially different from the frequency sensitive mechanism 130, instead of the frequency sensitive mechanism 130.

The frequency sensitive mechanism 130C includes a partition member 133C, which is partially different from the partition member 133, instead of the partition member 133. The partition member 133C includes an elastic seal member 162C, which is partially different from the elastic seal member 162, instead of the elastic seal member 162. The contact parts 166 and 167 are not provided in the elastic seal member 162C.

The frequency sensitive mechanism 130C includes a valve case 145C, which is partially different from the valve case 145, instead of the valve case 145. The valve case 145C includes a support member 141C, which is partially different from the support member 141, instead of the support member 141. The number of discs 135 in the support member 141C is different from that in the support member 141. The support member 141C is constituted by a plurality of (specifically, seven) discs 135 having the same outer diameter and the same inner diameter. The plurality of discs 136 constituting the valve seat member 142 are not provided in the valve case 145C. Instead of the discs 136, the number of discs 135 constituting the support member 141C is increased compared to the support member 141. The support member 141C has a larger axial thickness than the support member 141.

The valve case 145C includes a cover member 143C, which is partially different from the cover member 143, instead of the cover member 143. The cover member 143C includes a contact part 166C and a valve closing part 167C, both of which are formed of an elastic seal material, in addition to a plurality of (specifically, two) discs 137. The contact part 166C and the valve closing part 167C are both made of rubber and are both annular. Both the contact part 166C and the valve closing part 167C are disposed on an outer circumferential side of the disc 137, which is at an end portion of the plurality of discs 137 on the support member 141C side in an axial direction, to be coaxial with the disc 137, and are adhered by baking. Both the contact part 166C and the valve closing part 167C protrude from the disc 137 to the support member 141C side in the axial direction of the disc 137.

The contact part 166C has an annular shape and protrudes from the disc 137 to a bottom part 150 side in an axial direction of the cover member 143C. In the contact part 166C, a base end portion 170C on the disc 137 side in the axial direction of the cover member 143C is fixed to an outer circumferential edge portion of the disc 137.

An outer circumferential portion of the contact part 166C has an outer diameter that decreases with distance away from the disc 137 in the axial direction of the cover member 143C. An inner circumferential portion of a distal end portion 171C on a protruding side of the contact part 166C has an inner diameter that increases with distance away from the disc 137 in the axial direction of the cover member 143C. Therefore, a cross-sectional shape of the distal end portion 171C of the contact part 166C in a plane including a central axis of the cover member 143C is a tapered single-chevron shape that becomes thinner with distance away from the disc 137 in the axial direction of the cover member 143C.

A notch part 172C penetrating the distal end portion 171C in a radial direction of the cover member 143C is formed in the distal end portion 171C of the contact part 166C. A plurality of notch parts 172C are formed in the contact part 166C at intervals in a circumferential direction of the cover member 143C. Therefore, the distal end portion 171C of the contact part 166C is intermittently cut out in the circumferential direction of the cover member 143C.

The valve closing part 167C has an annular shape and protrudes from the disc 137 to the bottom part 150 side in the axial direction of the cover member 143C. The valve closing part 167C is provided on an inner circumferential side of the contact part 166C in the radial direction of the cover member 143C. In the valve closing part 167C, a base end portion 174C on the disc 137 side in the axial direction of the cover member 143C is fixed to the disc 137 on the inner circumferential side of the contact part 166C by baking. The base end portion 174C of the valve closing part 167C is connected to and integrated with the base end portion 170C of the contact part 166C.

An inner circumferential portion of the valve closing part 167C has an inner diameter that increases with distance away from the disc 137 in the axial direction of the cover member 143C. An outer circumferential portion of the distal end portion 175C on a protruding side of the valve closing part 167C has an outer diameter that decreases with distance away from the disc 137 in the axial direction of the cover member 143C. Therefore, a cross-sectional shape of the distal end portion 175C of the valve closing part 167C in a plane including the central axis of the cover member 143C is a tapered single-chevron shape that becomes thinner with distance away from the disc 137 in the axial direction of the cover member 143C. Therefore, the cover member 143C has a double-chevron shape formed of the distal end portion 171C of the contact part 166C and the distal end portion 175C of the valve closing part 167C. A cross-sectional shape of the distal end portion 175C of the valve closing part 167C in a plane including the central axis of the cover member 143C is consistent over the entire circumference. A protrusion height of the valve closing part 167C from the disc 137 is smaller than a protrusion height of the contact part 166C from the disc 137.

The cover member 143C has a recessed part 176C between the valve closing part 167C and the contact part 166C in the radial direction of the cover member 143C. The recessed part 176C is recessed from the distal end portion 171C of the contact part 166C and the distal end portion 175C of the valve closing part 167C to the disc 137 side in the axial direction of the cover member 143C. The recessed part 176C has an annular shape that is continuous over the entire circumference of the cover member 143C.

In the cover member 143C, the contact part 166C and the valve closing part 167C are disposed on the bottom part 150 side in the axial direction of the cover member 143C. The contact part 166C is in contact with a valve disc 161 of the partition member 133C at the distal end portion 171C. The contact part 166C biases a second support part 179 side of the valve disc 161 in the radial direction to a seat part 154 side in an axial direction of the valve disc 161.

The valve closing part 167C of the cover member 143C is on the support member 141C side in the axial direction of the cover member 143C. The valve closing part 167C of the cover member 143C is provided between the contact part 166C and the support member 141C in the radial direction of the cover member 143C.

In the partition member 133C, the valve disc 161 is displaced with respect to the cover member 143C when the valve disc 161 deforms in the axial direction of the partition member 133C, and thereby the valve disc 161 is separated from and seated on the valve closing part 167C. Further, the partition member 133C is not limited to being displaced in the axial direction by deformation, and may also be displaced in the axial direction by movement.

The valve disc 161 of the partition member 133C is bendable in a tapered shape such that the second support part 179 is separated from the seat part 154 while a first support part 178 remains in contact with the support member 141C. When bending in this manner, the valve disc 161 elastically deforms the contact part 166C of the cover member 143C in contact with the valve disc 161. Then, when the valve disc 161 bends by a predetermined amount, it comes into contact with the valve closing part 167C of the cover member 143C.

The partition member 133C is provided inside the valve case 145C and partitions the inside of the valve case 145C into a first chamber 181 and a second chamber 182. The first chamber 181 is provided between the bottom part 150 and the partition member 133C in the axial direction of the valve case 145C. The second chamber 182 is provided between the partition member 133C and the cover member 143C in the axial direction of the valve case 145C.

As shown in FIG. 7, in a state in which the valve disc 161 of the partition member 133C is separated from the valve closing part 167C of the cover member 143C, the entire second chamber 182 communicates with a lower chamber 20 through a passage part 185 between the cover member 143C and a cylindrical part 153 of a case member 131.

In a state in which the partition member 133C is deformed into a tapered shape and the valve disc 161 is in contact with the valve closing part 167C of the cover member 143C over the entire circumference, the second chamber 182 is partitioned into a pressure chamber on a radially inner side of the valve closing part 167C and a communication chamber on a radially outer side of the valve closing part 167C. The communication chamber communicates with the lower chamber 20 through the passage part 185. The pressure chamber does not communicate with the communication chamber, and therefore neither communicates with the lower chamber 20.

During an extension stroke, an oil fluid L from an upper chamber 19 (see FIG. 2) is introduced into the first chamber 181 via a first passage 43 (see FIG. 2), a passage in a notch 81 (see FIG. 2) of a disc 50 (see FIG. 2), a passage in a groove part 30 of a piston rod 21 shown in FIG. 7, and a passage in a passage groove 158 of the case member 131. Then, the valve disc 161 of the partition member 133C bends in a tapered shape so that the second support part 179 is separated from the bottom part 150 further than the first support part 178 in the axial direction of the case member 131 using a contact point with the support member 141C that is in contact at the first support part 178 as a fulcrum. At that time, the valve disc 161 compressively deforms the contact part 166C of the cover member 143C that comes into contact with the valve disc 161 in the axial direction of the case member 131.

Due to the displacement as described above, the partition member 133C increases a volume of the first chamber 181. Here, during this displacement of the partition member 133C, a volume of the second chamber 182 decreases. At that time, the oil fluid L in the second chamber 182 flows into the lower chamber 20 through the passage part 185.

Here, during the extension stroke, in a state in which the displacement of the partition member 133C is smaller than a predetermined amount, the valve disc 161 is separated from the valve closing part 167C of the cover member 143C, and therefore the oil fluid L flows from the entire second chamber 182 to the lower chamber 20 through the passage part 185.

On the other hand, during the extension stroke, in a state in which the displacement of the partition member 133C is equal to or larger than the predetermined amount, the valve disc 161 comes into contact with the valve closing part 167C of the cover member 143C over the entire circumference, and partitions the second chamber 182 into the pressure chamber on a radially inner side of the valve closing part 167C and the communication chamber on a radially outer side of the valve closing part 167C. The second chamber 182 is placed in a state in which the communication chamber communicates with the lower chamber 20 through the passage part 185, but the pressure chamber does not communicate with the lower chamber 20.

That is, in the frequency sensitive mechanism 130C, the partition member 133C is displaced by the oil fluid L that has flowed into the first chamber 181 due to movement of a piston 18 (see FIG. 2) during the extension stroke, and discharges at least some of the oil fluid L in the second chamber 182 constituting a second passage 191 into the lower chamber 20 in a cylinder 2 (see FIG. 2). Also, in the frequency sensitive mechanism 130C, the valve closing part 167C forms the pressure chamber closed between the cover member 143 in the second passage 191 and the partition member 133C, thereby restricting movement of the oil fluid L in the pressure chamber. The pressure chamber is formed when the partition member 133C and the valve closing part 167C of the cover member 143C in the second passage 191 come into contact with each other due to the displacement of the partition member 133C. The valve closing part 167C is provided in the second passage 191, and is formed of an elastic member that deforms to come into contact with the partition member 133C after the displacement of the partition member 133C and allow the partition member 133C to be displaceable even after the contact. In the frequency sensitive mechanism 130C, the partition member 133C is provided in the second passage 191. The partition member 133C partitions the second passage 191 between the first chamber 181 and the second chamber 182.

The shock absorber 1C varies the damping force according to a piston frequency similarly to the shock absorber 1.

In the shock absorber 1C of the fourth embodiment, the frequency sensitive mechanism 130C provided in the second passage 191 to vary the damping force includes the valve closing part 167C that forms the pressure chamber closed between the cover member 143C in the second passage 191 and the partition member 133C to restrict movement of the oil fluid L in the pressure chamber. In the shock absorber 1C, when the valve closing part 167C forms the pressure chamber closed between the inside of the second passage 191 and the partition member 133C, if a pressure in the first chamber 181 on a side of the partition member 133C opposite to the pressure chamber in the second passage 191 increases, a pressure inside the pressure chamber also increases accordingly, thereby suppressing the displacement of the partition member 133C. In this way, since the shock absorber 1C can suppress the displacement of the partition member 133C, durability of the partition member 133C can be enhanced. Also, since the shock absorber 1C suppresses the displacement of the partition member 133C by the pressure of the oil fluid L, it is possible to suppress occurrence of abnormal noise. Also, since the shock absorber 1C can gently suppress the displacement of the partition member 133C by the pressure of the oil fluid L, it is possible to suppress a decrease in ride comfort that occurs due to a sudden change in damping force.

Also, in the shock absorber 1C, the pressure chamber is formed when the partition member 133C and the valve closing part 167C in the second passage 191 come into contact with each other due to the displacement of the partition member 133C. In the shock absorber 1C, the pressure chamber is formed by the displacement of the partition member 133C as described above. Therefore, the shock absorber 1C, by using the displacement of the partition member 133C, can vary the damping force by easily displacing the partition member 133C without forming the pressure chamber, or can suppress the displacement of the partition member 133C by forming the pressure chamber.

Also, in the shock absorber 1C, the valve closing part 167C is provided on the cover member 143C which is a part of the second passage 191, and is formed of an elastic member that deforms to come into contact with the partition member 133C after the displacement of the partition member 133C and allow the partition member 133C to be displaceable even after the contact. Therefore, the shock absorber 1C can more gently suppress the displacement of the partition member 133C at the time of suppressing the displacement.

### Fifth Embodiment

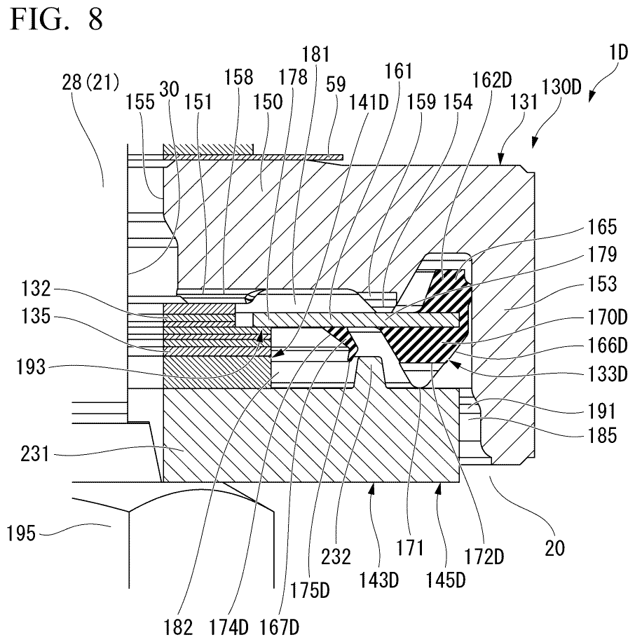

Next, a fifth embodiment will be described mainly on the basis of FIG. 8 focusing on differences from the first embodiment. Also, parts common to those in the first embodiment will be denoted by the same terms and the same reference signs.

As shown in FIG. 8, a shock absorber 1D of the fifth embodiment includes a frequency sensitive mechanism 130D (second damping force mechanism), which is partially different from the frequency sensitive mechanism 130, instead of the frequency sensitive mechanism 130.

The frequency sensitive mechanism 130D includes a partition member 133D, which is partially different from the partition member 133, instead of the partition member 133. The partition member 133D includes an elastic seal member 162D, which is partially different from the elastic seal member 162, instead of the elastic seal member 162. The elastic seal member 162D includes a contact part 166D, which is partially different from the contact part 166, instead of the contact part 166. The elastic seal member 162D includes a valve closing part 167D, which is partially different from the valve closing part 167, instead of the valve closing part 167.

The contact part 166D includes a base end portion 170D, which is partially different from the base end portion 170, instead of the base end portion 170. The contact part 166D has an annular shape, and the base end portion 170D on a valve disc 161 side in an axial direction of the partition member 133D is fixed to an outer circumferential side of the valve disc 161 by baking.

An inner circumferential portion of the contact part 166D has an inner diameter that increases with distance away from the valve disc 161 in the axial direction of the partition member 133D. An outer circumferential portion of the contact part 166D has an outer diameter that decreases with distance away from the valve disc 161 in the axial direction of the partition member 133D. Therefore, a cross-sectional shape of the contact part 166D in a plane including a central axis of the partition member 133D is a tapered single-chevron shape that becomes thinner with distance away from the valve disc 161 in the axial direction of the partition member 133D.

The valve closing part 167D is provided apart from the contact part 166D in a radial direction of the partition member 133D. The valve closing part 167D is fixed to the valve disc 161 by baking. A base end portion 174D of the valve closing part 167D on the valve disc 161 side in the axial direction of the partition member 133D increases in diameter such that an outer diameter and an inner diameter thereof become larger with distance away from the valve disc 161 in the axial direction of the partition member 133D. A distal end portion 175D of the valve closing part 167D on a side opposite to the valve disc 161 in the axial direction of the partition member 133D decreases in diameter such that an outer diameter and an inner diameter thereof become smaller with distance away from the valve disc 161 in the axial direction of the partition member 133D. A cross-sectional shape of the valve closing part 167D in a plane including the central axis of the partition member 133D is consistent over the entire circumference.

The frequency sensitive mechanism 130D includes a valve case 145D, which is partially different from the valve case 145, instead of the valve case 145. The valve case 145D includes a support member 141D, which is partially different from the support member 141, instead of the support member 141. The support member 141D is constituted by a plurality of (specifically, five) discs 135 having the same outer diameter and the same inner diameter. The plurality of discs 136 constituting the valve seat member 142 are not provided in the valve case 145D. Instead of the discs 136, among the discs 135 constituting the support member 141D, the disc 135 on a side furthest away from the disc 132 in the axial direction of the support member 141D has a larger thickness. The support member 141D has a larger axial thickness than the support member 141.

One cover member 143D is provided in the valve case 145D instead of the cover member 143 and the annular member 138. The cover member 143D has a main body part 231 and a protruding part 232. The cover member 143D is made of a metal, and the main body part 231 and the protruding part 232 are seamlessly and integrally formed by sintering or the like.

The main body part 231 has a perforated disc shape, and has a constant outer diameter over the entire circumference and a constant radial width over the entire circumference. The main body part 231 has an axial thickness equal to a thickness of the annular member 138. The main body part 231 of the valve case 145D is fitted onto a mounting shaft part 28 of a piston rod 21.

An outer circumferential portion of the protruding part 232 has a tapered shape that is coaxial with the main body part 231, and a diameter thereof decreases with distance away from the main body part 231 in the axial direction. The inner circumferential portion of the protruding part 232 has a tapered shape that is coaxial with the main body part 231, and a diameter thereof increases with distance away from the main body part 231 in the axial direction. A cross-sectional shape of the protruding part 232 in a plane including a central axis of the cover member 143D is consistent over the entire circumference.

In the partition member 133D, the contact part 166D and the valve closing part 167D are disposed on a side opposite to a bottom part 150 in the axial direction of the partition member 133D. The contact part 166D is in contact with the main body part 231 of the cover member 143D at a distal end portion 171 thereof. The contact part 166D biases a second support part 179 side of the valve disc 161D in the radial direction to a seat part 154 side in the axial direction of the valve disc 161.

The protruding part 232 of the cover member 143D is on the support member 141D side in an axial direction of the cover member 143D. The protruding part 232 of the cover member 143D is provided between the contact part 166D and the valve closing part 167D in a radial direction of the cover member 143D. A maximum outer diameter of the valve closing part 167D is equal to a maximum inner diameter of the protruding part 232.

In the partition member 133D, when the valve disc 161 deforms in the axial direction of the partition member 133D, the valve closing part 167D is displaced with respect to the cover member 143D, and thereby the valve disc 161 is separated from and seated on the protruding part 232 of the cover member 143D. Further, the partition member 133D is not limited to being displaced in the axial direction by deformation, and may also be displaced in the axial direction by movement.

The valve disc 161 of the partition member 133D is bendable in a tapered shape such that the second support part 179 is separated from the seat part 154 while a first support part 178 remains in contact with the support member 141. When bending in this manner, the valve disc 161 elastically deforms the contact part 166D in contact with the main body part 231 of the cover member 143D. Then, when the valve disc 161 bends by a predetermined amount, the valve closing part 167D comes into contact with and fits to an inner circumferential portion of the protruding part 232 of the cover member 143.

The partition member 133D is provided inside the valve case 145D and partitions the inside of the valve case 145D into a first chamber 181 and a second chamber 182. The first chamber 181 is provided between a bottom part 150 and the partition member 133D in an axial direction of the valve case 145D. The second chamber 182 is provided between the partition member 133D and the cover member 143D in the axial direction of the valve case 145D.

As shown in FIG. 8, in a state in which the valve closing part 167D of the partition member 133D is separated from the protruding part 232 of the cover member 143D, the entire second chamber 182 communicates with a lower chamber 20 through a passage part 185 between the main body part 231 of the cover member 143D and a cylindrical part 153 of a case member 131.

In a state in which the valve closing part 167D of the partition member 133D comes into contact with and fits to the protruding part 232 of the cover member 143D, the second chamber 182 is partitioned into a pressure chamber on a radially inner side of the valve closing part 167D and a communication chamber on a radially outer side of the valve closing part 167D. The communication chamber communicates with the lower chamber 20 through the passage part 185. The pressure chamber does not communicate with the communication chamber, and therefore neither communicates with the lower chamber 20.

During an extension stroke, an oil fluid L from an upper chamber 19 (see FIG. 2) is introduced into the first chamber 181 via a first passage 43 (see FIG. 2), a passage in a notch 81 (see FIG. 2) of a disc 50 (see FIG. 2), a passage in a groove part 30 of the piston rod 21 shown in FIG. 8, and a passage in a passage groove 158 of the case member 131. Then, the valve disc 161 of the partition member 133D bends in a tapered shape so that the second support part 179 is separated from the bottom part 150 further than the first support part 178 in the axial direction of the case member 131 using a contact point with the support member 141 that is in contact at the first support part 178 as a fulcrum. At that time, the valve disc 161 compressively deforms the contact part 166D that comes into contact with the cover member 143D in the axial direction of the case member 131.

Due to the displacement as described above, the partition member 133D increases a volume of the first chamber 181. Here, during this displacement of the partition member 133D, a volume of the second chamber 182 decreases. At that time, the oil fluid L in the second chamber 182 flows into the lower chamber 20 through the passage part 185.

Here, during the extension stroke, in a state in which the displacement of the partition member 133D is smaller than a predetermined amount, the valve closing part 167D is separated from the protruding part 232 of the cover member 143D, and therefore the oil fluid L flows from the entire second chamber 182 to the lower chamber 20 through the passage part 185.

On the other hand, during the extension stroke, in a state in which the displacement of the partition member 133D is equal to or larger than the predetermined amount, the valve closing part 167D comes into contact with and fits to the protruding part 232 of the cover member 143D, and partitions the second chamber 182 into the pressure chamber on a radially inner side of the valve closing part 167D and the communication chamber on a radially outer side of the valve closing part 167D. The second chamber 182 is placed in a state in which the communication chamber communicates with the lower chamber 20 through the passage part 185, but the pressure chamber does not communicate with the lower chamber 20.

That is, in the frequency sensitive mechanism 130D, the partition member 133D is displaced by the oil fluid L that has flowed into the first chamber 181 due to movement of a piston 18 (see FIG. 2) during the extension stroke, and discharges at least some of the oil fluid L in the second chamber 182 constituting a second passage 191 into the lower chamber 20 in a cylinder 2 (see FIG. 2). Also, in the frequency sensitive mechanism 130D, the valve closing part 167D forms the pressure chamber that is closed between the cover member 143D in the second passage 191 and the partition member 133D, thereby restricting movement of the oil fluid L in the pressure chamber. The pressure chamber is formed when the valve closing part 167D of the partition member 133D and the protruding part 232 of the cover member 143D in the second passage 191 come into contact with and fit to each other due to the displacement of the partition member 133D. The valve closing part 167D is provided in the partition member 133D, and is formed of an elastic member that deforms to come into contact with and fit to the protruding part 232 after the displacement of the partition member 133D and allow the partition member 133D to be displaceable even after the contact. In the frequency sensitive mechanism 130D, the partition member 133D is provided in the second passage 191. The partition member 133D partitions the second passage 191 between the first chamber 181 and the second chamber 182.

The shock absorber 1D varies the damping force according to a piston frequency similarly to the shock absorber 1.

In the shock absorber 1D of the fifth embodiment, the frequency sensitive mechanism 130D provided at the second passage 191 to vary the damping force includes the valve closing part 167D that forms the pressure chamber closed between the cover member 143D in the second passage 191 and the partition member 133D to restrict movement of the oil fluid L in the pressure chamber. In the shock absorber 1D, when the valve closing part 167D forms the pressure chamber closed between the inside of the second passage 191 and the partition member 133D, if a pressure in the first chamber 181 on a side of the partition member 133D opposite to the pressure chamber in the second passage 191 increases, a pressure inside the pressure chamber also increases accordingly, thereby suppressing the displacement of the partition member 133D. In this way, since the shock absorber 1D can suppress the displacement of the partition member 133D, durability of the partition member 133D can be enhanced. Also, since the shock absorber 1D suppresses the displacement of the partition member 133D by the pressure of the oil fluid L, it is possible to suppress occurrence of abnormal noise. Also, since the shock absorber 1D can gently suppress the displacement of the partition member 133D by the pressure of the oil fluid L, it is possible to suppress a decrease in ride comfort that occurs due to a sudden change in damping force.

Also, in the shock absorber 1D, the pressure chamber is formed when the valve closing part 167D provided in the partition member 133D and the cover member 143D in the second passage 191 come into contact with each other due to the displacement of the partition member 133D. In the shock absorber 1D, the pressure chamber is formed by the displacement of the partition member 133D as described above. Therefore, the shock absorber 1D, by using the displacement of the partition member 133D, can vary the damping force by easily displacing the partition member 133D without forming the pressure chamber, or can suppress the displacement of the partition member 133D by forming the pressure chamber.

Also, in the shock absorber 1D, the valve closing part 167D is provided in the partition member 133D, and is formed of an elastic member that deforms to come into contact with the cover member 142D of the second passage 191 after the displacement of the partition member 133D and allow the partition member 133D to be displaceable even after the contact. Therefore, in the shock absorber 1D, the pressure chamber can be easily formed by the displacement of the partition member 133D, and the displacement of the partition member 133D can be more gently suppressed at the time of suppressing the displacement.

### Sixth Embodiment

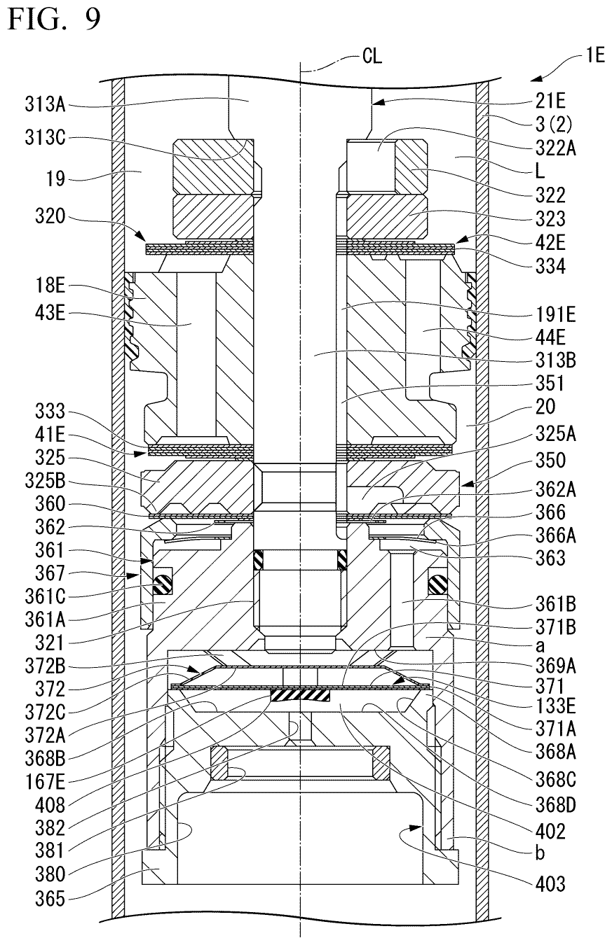

Next, a sixth embodiment will be described mainly on the basis of FIG. 9 focusing on differences from the first embodiment. Also, parts common to those in the first embodiment will be denoted by the same terms and the same reference signs.

As shown in FIG. 9, a shock absorber 1E of the sixth embodiment includes a piston rod 21E, which is partially different from the piston rod 21. The piston rod 21E includes a main shaft part 313A and a mounting shaft part 313B which has an outer diameter smaller than an outer diameter of the main shaft part 313A.

An insertion end of the piston rod 21E into an inner cylinder 3 of a cylinder 2 is the mounting shaft part 313B. In the piston rod 21E, a boundary between the main shaft part 313A and the mounting shaft part 313B is a shaft step part 313C having a stepped shape. A side of the piston rod 21E opposite to the mounting shaft part 313B in an axial direction of the main shaft part 313A is inserted through a rod guide 22 (see FIG. 1) and a seal member 23 (see FIG. 1) and extends to the outside of the cylinder 2.

The shock absorber 1E includes a piston valve device 320. The piston valve device 320 includes stopper pieces 322 and 323, a piston 18E, and a valve stopper 325, all of which are fitted onto an outer circumference of the mounting shaft part 313B of the piston rod 21E. The stopper pieces 322 and 323, the piston 18E, and the valve stopper 325 are clamped and fixed between a valve housing 361 screwed onto a screw part 321 at a distal end of the mounting shaft part 313B and the shaft step part 313C of the piston rod 21E. The stopper pieces 322 and 323, the piston 18E, and the valve stopper 325 are connected to the mounting shaft part 313B of the piston rod 21E. The valve housing 361 is a component for a sub extension-side damping valve 360. Further, the stopper piece 322 has a flow path 322A that communicates with a bypass passage 351 (to be described later) of the piston rod 21E to open to an upper chamber 19 in the inner cylinder 3.

The piston 18E is fitted in the inner cylinder 3 to be slidable. A first passage 43E on an extension side and a first passage 44E on a compression side are provided in the piston 18E. The first passage 43E and the first passage 44E allow communication between the upper chamber 19 and a lower chamber 20 so that an oil fluid L can flow between them due to movement of the piston 18E. The piston 18E clamps an annular center portion of a disc valve-shaped main extension-side damping valve 333 between itself and the valve stopper 325. A portion of the piston 18E, where the main extension-side damping valve 333 is separated from and seated on, and the main extension-side damping valve 333 constitute a damping force mechanism 41E (first damping force mechanism) that opens and closes the first passage 43E.

The piston 18E clamps an annular center portion of a disc valve-shaped compression-side damping valve 334 between itself and the stopper piece 323. A portion of the piston 18E, where the compression-side damping valve 334 is separated from and seated on, and the compression-side damping valve 334 constitute a damping force mechanism 42E (first damping force mechanism) that opens and closes the first passage 44E. The piston valve device 320 partitions the inside of the inner cylinder 3 into the upper chamber 19 and the lower chamber 20 by the piston 18E. Also, the piston valve device 320 allows communication between the upper chamber 19 and the lower chamber 20 via the first passage 43E provided in the piston 18E and the main extension-side damping valve 333 that opens and closes the first passage 43E. Also, the piston valve device 320 allows communication between the upper chamber 19 and the lower chamber 20 via the first passage 44E and the compression-side damping valve 334 that opens and closes the first passage 44E.

Therefore, in the shock absorber 1E, during an extension stroke, the oil fluid L in the upper chamber 19 passes through the first passage 43E of the piston 18E, opens the main extension-side damping valve 333 provided at the first passage 43E by bending and deforming it, and is guided to the lower chamber 20. At that time, the main extension-side damping valve 333 generates an extension-side damping force. Also, during a compression stroke, the oil fluid L in the lower chamber 20 passes through the first passage 44E of the piston 18E, opens the compression-side damping valve 334 by bending and deforming it, and is guided to the upper chamber 19. At that time, the compression-side damping valve 334 generates a compression-side damping force.

The shock absorber 1E includes an extension-side damping force adjustment mechanism 350 (second damping force mechanism) for varying and adjusting a damping force of the piston valve device 320, specifically the extension-side damping force in the present embodiment, as follows.

The extension-side damping force adjustment mechanism 350 has the bypass passage 351 provided on an outer surface of the piston rod 21E to extend to bypass the main extension-side damping valve 333 to allow communication between the upper chamber 19 and the lower chamber 20.

In the extension-side damping force adjustment mechanism 350, the sub extension-side damping valve 360 is provided at the bypass passage 351. The valve stopper 325 is inserted onto the mounting shaft part 313B of the piston rod 21E. A main body 361A of the valve housing 361 is screwed on the screw part 321 of the mounting shaft part 313B of the piston rod 21E. An annular center portion of the disc valve-shaped sub extension-side damping valve 360 is clamped between a lower-end central annular protruding part of the valve stopper 325 and an upper-end central annular protruding part of the main body 361A. The extension-side damping force adjustment mechanism 350 opens to the upper chamber 19 at one end of the bypass passage 351 and opens to a sub flow path 325A provided in the valve stopper 325 at the other end of the bypass passage 351. The extension-side damping force adjustment mechanism 350 opens and closes the sub flow path 325A with respect to the lower chamber 20 by the sub extension-side damping valve 360.

The extension-side damping force adjustment mechanism 350 includes the sub extension-side damping valve 360 attached to the valve stopper 325 to be brought into contact with and separated from a piston round 325B of the valve stopper 325. Then, the extension-side damping force adjustment mechanism 350 includes a back pressure chamber 363, which communicates with the upper chamber 19 via an orifice 362A of a slit valve 362, on a back surface side of the sub extension-side damping valve 360. The extension-side damping force adjustment mechanism 350 closes the back pressure chamber 363 with a partition member 133E having one or more laminated leaf springs 371. The slit valve 362 is attached to a back surface of the sub extension-side damping valve 360. An annular center portion of the slit valve 362 is clamped between a lower-end central annular protruding part of the valve stopper 325 and an upper-end central annular protruding part of the main body 361A of the valve housing 361. The slit valve 362 has a slit, which constitutes the orifice 362A, formed on an inner circumference.

The valve housing 361 of the extension-side damping force adjustment mechanism 350 has the main body 361A that is screwed onto the screw part 321 of the mounting shaft part 313B of the piston rod 21E. The main body 361A of the extension-side damping force adjustment mechanism 350 has a circular plate part a screwed onto the screw part 321, and an annular part b provided to protrude from a lower portion on an outer circumferential side of the circular plate part a. In the extension-side damping force adjustment mechanism 350, an end cap 365 is screwed on an inner circumference of the annular part b of the main body 361A. The valve housing 361 has a plurality of communication holes 361B at a plurality of positions in a circumferential direction of the circular plate part a of the main body 361A. The valve housing 361 allows the plurality of communication holes 361B to communicate with the back pressure chamber 363 on both sides in an axial direction of the valve housing 361 inside the valve housing 361.

The back pressure chamber 363 is partitioned from the lower chamber 20 by the valve housing 361, a backup collar 367, and a partition member 133E. The backup collar 367 is slidably provided on an outer circumference of the circular plate part a of the main body 361A of the valve housing 361. The backup collar 367 is biased to be in contact with the back surface of the sub extension-side damping valve 360 by the spring 366. The partition member 133E is supported by a valve seat 368A, which is an upper end portion of the end cap 365 on the back pressure chamber 363 side, to be able to come into contact with and separate from the valve seat 368A.

A seal material 361C is mounted in an annular groove on the outer circumference of the circular plate part a of the main body 361A of the valve housing 361. The backup collar 367 vertically slides with respect to the seal material 361C in a liquid-tight state. An upper end surface of the backup collar 367 comes into contact with the back surface of the sub extension-side damping valve 360. The spring 366 has a cross-shaped overhanging part 366A on an outer circumference of an annular center portion. The spring 366 is supported by the annular center portion seated on an upper surface around the upper-end central annular protruding part of the main body 361A of the valve housing 361. The spring 366 supports the backup collar 367 on an upper distal end portion of the overhanging part 366A.

The extension-side damping force adjustment mechanism 350 has the valve housing 361 attached to the piston rod 21E, the backup collar 367, and the back pressure chamber 363 on the back surface side of the sub extension-side damping valve 360. The backup collar 367 is provided to an outer circumference of the valve housing 361 to be slidable and is pressed against the back surface of the sub extension-side damping valve 360. The back pressure chamber 363 is formed to be partitioned from the lower chamber 20 by the partition member 133E. Then, the extension-side damping force adjustment mechanism 350 biases and presses an upper end surface of the backup collar 367 against the back surface of the sub extension-side damping valve 360 with the spring 366, which is supported by being seated on an upper surface of the circular plate part a of the main body 361A of the valve housing 361, inside the back pressure chamber 363.

The partition member 133E has a no-hole disc-shaped leaf spring 371. The partition member 133E has a support spring 372, and is supported such that a supported part 371A on an outer circumference of the leaf spring 371 is seated on the valve seat 368A of the end cap 365 by the support spring 372. The support spring 372 is an annular spring of a thin plate. The support spring 372 includes a plurality of upward spring legs 372B and a plurality of downward spring legs 372C at regular intervals on an outer circumference of a plate-shaped annular part 372A. The spring legs 372B each extend obliquely upward from an outer circumferential portion of the annular part 372A. The spring legs 372C each extend obliquely downward from the outer circumferential portion of the annular part 372A. The spring legs 372B and the spring legs 372C are alternately provided in a circumferential direction of the annular part 372A on the outer circumference of the annular part 372A. In the support spring 372, the upward spring leg 372B is in contact with a spring contact surface 369A which is a lower end surface of the circular plate part a of the main body 361A of the valve housing 361. In the support spring 372, the downward spring leg 372C is in contact with the leaf spring 371. Thereby, the support spring 372 presses the supported part 371A of the leaf spring 371 against the valve seat 368A of the end cap 365 to seat it thereon.

The outer circumference of the leaf spring 371 of the partition member 133E is not fixedly held on the valve seat 368A of the end cap 365. The outer circumference of the leaf spring 371 slides along a surface of the valve seat 368A and is free to move. A spring constant of the leaf spring 371 is set to be low. The support spring 372 of the partition member 133E slides along the spring contact surface 369A of the valve housing 361 and is also free to move.

A concave surface 368B restricting bending of the leaf spring 371 of the partition member 133E is provided in the end cap 365. The concave surface 368B restricts an amount of bending of an elastic bending part 371B on a radially inner side of the supported part 371A of the leaf spring 371 which is pushed by a pressure of the back pressure chamber 363 and bent into a curved shape. The concave surface 368B is provided on an inner circumferential side of the end cap 365 surrounded by the valve seat 368A to form a constant step with respect to the valve seat 368A. The concave surface 368B is formed of a tapered downwardly inclined surface 368C provided at a boundary portion with the valve seat 368A, and a flat surface 368D that is continuous with an inner circumferential side of the downwardly inclined surface 368C. The concave surface 368B forms a step with respect to the valve seat 368A by a depth of the flat surface 368D. The valve seat 368A and the concave surface 368B have a circular shape. The downwardly inclined surface 368C has a conical tapered surface.

The leaf spring 371 of the partition member 133E partitions the back pressure chamber 363 described above and the chamber 402. The chamber 402 communicates with the lower chamber 20 through a communication hole 403 provided in the end cap 365. The communication hole 403 has a large diameter hole 380 that opens to the lower chamber 20, an intermediate hole 381 having a smaller diameter than the large diameter hole 380, and a small diameter hole 382 having a smaller diameter than the intermediate hole 381 and opening at a radial center of the flat surface 368D of the concave surface 368B. The flow path 322A, the bypass passage 351, the orifice 362A, the back pressure chamber 363, the chamber 402, and the communication hole 403 constitute a second passage 191E. The second passage 191E is provided in parallel with the first passage 43E and the first passage 44E. The second passage 191E is provided to allow the oil fluid L in the upper chamber 19 to flow in due to movement of the piston 18E during the extension stroke. The second passage 191E is provided to allow the oil fluid L in the lower chamber 20 to flow in due to movement of the piston 18E during the compression stroke.

A valve closing part 167E formed of an elastic seal material is provided on the chamber 402 side of the leaf spring 371 in the partition member 133E. The valve closing part 167E is made of rubber and has a disc shape. The valve closing part 167E is adhered to a center position of the leaf spring 371 in the radial direction. The valve closing part 167E is provided integrally with the leaf spring 371 by being baked to the metal leaf spring 371. The valve closing part 167E has an annular closing part 408 that protrudes in the axial direction further than the inside at an outer circumferential edge portion. A cross-sectional shape of the valve closing part 167E in a plane including a central axis thereof is consistent over the entire circumference.

As shown in FIG. 9, in a state in which the valve closing part 167E of the partition member 133E is separated from the end cap 365, the entire chamber 402 communicates with the lower chamber 20 through the communication hole 403 of the end cap 365.

When the leaf spring 371 of the partition member 133E bends to the flat surface 368D side of the end cap 365, the valve closing part 167E comes into contact with the flat surface 368D over the entire circumference such that the closing part 408 surrounds the small diameter hole 382 of the communication hole 403. Then, the valve closing part 167E closes the communication hole 403. In this state, the chamber 402 forms a pressure chamber that is closed radially outward from the valve closing part 167E. The pressure chamber does not communicate with the lower chamber 20.

During the extension stroke, the leaf spring 371 of the partition member 133E receives a pressure of the back pressure chamber 363 to which a pressure of the pressurized upper chamber 19 is applied from the bypass passage 351 through the orifice 362A. During the extension stroke, the leaf spring 371 of the partition member 133E receives the pressure of the back pressure chamber 363 and causes the supported part 371A to be seated on the valve seat 368A of the end cap 365. At the same time, the partition member 133E elastically deforms the elastic bending part 371B of the leaf spring 371 toward the concave surface 368B of the end cap 365 to reduce a volume of the chamber 402 while increasing a volume of the back pressure chamber 363.

During the opposite compression stroke, in the partition member 133E, a pressure of the pressurized lower chamber 20 is transmitted from the communication hole 403 opening to the lower chamber 20 of the end cap 365 to the leaf spring 371 via the chamber 402. Therefore, the partition member 133E allows the pressure of the lower chamber 20 to be introduced into the back pressure chamber 363 by bending the support spring 372 and separating the supported part 371A of the leaf spring 371 from the valve seat 368A of the end cap 365.

The partition member 133E repeats the extension stroke and the compression stroke described above, and increases a volume of the back pressure chamber 363 during the extension stroke, causing a delay in transmission of the pressure of the upper chamber 19. The partition member 133E allows spring constants of the leaf spring 371 and the support spring 372 to be set independently of each other, and can generate a delay in pressure transmission from the upper chamber 19 to the back pressure chamber 363 by reducing the number of the laminated leaf spring 371 to set the extension side to be weaker, and adjust a response speed of the damping force of the piston valve device 320 and the extension-side damping force adjustment mechanism 350.

The partition member 133E is provided at the second passage 191E, and partitions the second passage 191E between the back pressure chamber 363 and the chamber 402. At the same time, the partition member 133E is displaced by the oil fluid L that has flowed in due to movement of the piston 18E and discharges at least some of the oil fluid L in the second passage 191E into the lower chamber 20 in the cylinder 2.

Therefore, the shock absorber 1E includes the extension-side damping force adjustment mechanism 350 and operates as follows.

During the extension stroke, when movement of the piston 18E of the shock absorber 1E is in a normal low-frequency large-stroke range, a pressure in the pressurized upper chamber 19 is transmitted to the back pressure chamber 363 with almost no delay in pressure transmission due to the orifice 362A, and pushes and strokes the leaf spring 371 of the partition member 133E. Thereafter, when a pressure in the back pressure chamber 363 increases, the sub extension-side damping valve 360 receiving the pressure of the back pressure chamber 363 does not open, and the main extension-side damping valve 333 opens to generate a damping force. The main extension-side damping valve 333 has a higher bending rigidity than the sub extension-side damping valve 360 to enhance steering stability during normal traveling, and generates a damping force normally required.

During the extension stroke, when the vehicle rides over an uneven road surface and movement of the piston 18E enters a high-frequency small-stroke range, the pressure in the pressurized upper chamber 19 is accompanied by a delay in pressure transmission due to the orifice 362A, does not increase the pressure in the back pressure chamber 363, and makes the sub extension-side damping valve 360 easier to open, thereby reducing the damping force.

During the compression stroke, the compression-side damping valve 334 opens to generate a damping force.

Here, during the extension stroke, when a displacement of the leaf spring 371 of the partition member 133E is smaller than a predetermined amount, the valve closing part 167E is separated from the flat surface 368D of the end cap 365, and therefore, the oil fluid L flows from the entire chamber 402 to the lower chamber 20 through the communicating hole 403.

On the other hand, during the extension stroke, when the displacement of the leaf spring 371 of the partition member 133E is equal to or larger than the predetermined amount, the closing part 408 of the valve closing part 167E comes into contact with the flat surface 368D of the end cap 365 over the entire circumference and forms the closed pressure chamber on a radially outward side with respect to the valve closing part 167E of the chamber 402. The pressure chamber does not communicate with the lower chamber 20.

That is, in the extension-side damping force adjustment mechanism 350, the leaf spring 371 of the partition member 133E is displaced by the oil fluid L that has flowed into the back pressure chamber 363 due to movement of the piston 18E during the extension stroke, and discharges at least some of the oil fluid L in the chamber 402 constituting the second passage 191E into the lower chamber 20 in the cylinder 2. Also, in the extension-side damping force adjustment mechanism 350, the valve closing part 167E forms the pressure chamber that is closed between the flat surface 368D in the second passage 191E of the end cap 365 and the partition member 133E, thereby restricting movement of the oil fluid L in the pressure chamber. The pressure chamber is formed when the valve closing part 167E and the flat surface 368D in the second passage 191E of the end cap 365 come into contact with each other due to the displacement of the leaf spring 371 of the partition member 133E. The valve closing part 167E is provided on the leaf spring 371 of the partition member 133E, and is formed of an elastic member that deforms to come into contact with the flat surface 368D of the end cap 365 of the second passage 191E after the displacement of the leaf spring 371 and allow the leaf spring 371 to be displaceable even after the contact. In the extension-side damping force adjustment mechanism 350, the partition member 133E is provided at the second passage 191E. The partition member 133E partitions the second passage 191E between the back pressure chamber 363 and the chamber 402.

In the shock absorber 1E of the sixth embodiment, the extension-side damping force adjustment mechanism 350 provided at the second passage 191E to vary the damping force includes the valve closing part 167E that forms the pressure chamber closed between the flat surface 368D in the second passage 191E of the end cap 365 and the leaf spring 371 of the partition member 133E to restrict movement of the oil fluid L in the pressure chamber. In the shock absorber 1E, when the valve closing part 167E forms the pressure chamber closed between the inside of the second passage 191E and the leaf spring 371 of the partition member 133E, if a pressure of the back pressure chamber 363 on a side of the partition member 133E opposite to the pressure chamber in the second passage 191E increases, a pressure inside the pressure chamber also increases accordingly, thereby suppressing the displacement of the leaf spring 371 of the partition member 133E. In this way, since the shock absorber 1E can suppress the displacement of the partition member 133E, durability of the partition member 133E can be enhanced. Also, since the shock absorber 1E suppresses the displacement of the partition member 133E by the pressure of the oil fluid L, it is possible to suppress occurrence of abnormal noise. Also, since the shock absorber 1E can gently suppress the displacement of the partition member 133E by the pressure of the oil fluid L, it is possible to suppress a decrease in ride comfort that occurs due to a sudden change in damping force.

Also, in the shock absorber 1E, the pressure chamber is formed when the flat surface 368D in the second passage 191E of the end cap 365 and the valve closing part 167E come into contact with each other due to the displacement of the leaf spring 371 of the partition member 133E. In the shock absorber 1E, the pressure chamber is formed by the displacement of the leaf spring 371 of the partition member 133E as described above. Therefore, the shock absorber 1E, by using the displacement of the partition member 133E, can vary the damping force by easily displacing the partition member 133E without forming the pressure chamber, or can suppress the displacement of the partition member 133E by forming the pressure chamber.

Also, in the shock absorber 1E, the valve closing part 167E is provided on the leaf spring 371 of the partition member 133E, and is formed of an elastic member that deforms to come into contact with the flat surface 368D of the end cap 365 of the second passage 191E after the displacement of the leaf spring 371 and allow the leaf spring 371 to be displaceable even after the contact. Therefore, in the shock absorber 1E, the pressure chamber can be easily formed by the displacement of the partition member 133E, and the displacement of the partition member 133E can be more gently suppressed at the time of suppressing the displacement.

### Seventh Embodiment

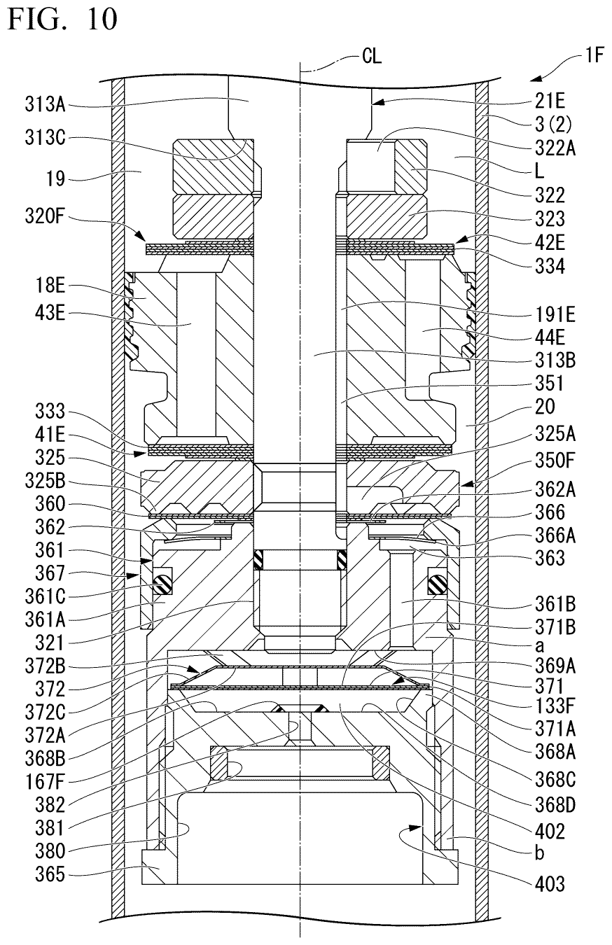

Next, a seventh embodiment will be described mainly on the basis of FIG. 10 focusing on differences from the sixth embodiment. Also, parts common to those in the sixth embodiment will be denoted by the same terms and the same reference signs.

As shown in FIG. 10, a shock absorber 1F of the seventh embodiment includes a piston valve device 320F, which is partially different from the piston valve device 320, instead of the piston valve device 320. The piston valve device 320F includes an extension-side damping force adjustment mechanism 350F (second damping force mechanism), which is partially different from the extension-side damping force adjustment mechanism 350, instead of the extension-side damping force adjustment mechanism 350. The extension-side damping force adjustment mechanism 350F includes a partition member 133F, which is partially different from the partition member 133E, instead of the partition member 133E. The partition member 133F differs from the partition member 133E in that the valve closing part 167E is not provided.

In the extension-side damping force adjustment mechanism 350F, an annular valve closing part 167F is provided on a flat surface 368D of a concave surface 368B of an end cap 365 to surround a small diameter hole 382. The valve closing part 167F is formed of an elastic seal material. The valve closing part 167F is made of rubber and has an annular shape. An inner circumferential portion of the valve closing part 167B has an inner diameter that increases with distance away from the flat surface 368D in an axial direction of the end cap 365. An outer circumferential portion of the valve closing part 167F has an outer diameter that decreases with distance away from the flat surface 368D in an axial direction of a valve seat member 142B. Therefore, a cross-sectional shape of the valve closing part 167F in a plane including a central axis of the end cap 365 is a tapered single-chevron shape that becomes thinner with distance away from the flat surface 368D in the axial direction of the end cap 365. A cross-sectional shape of the valve closing part 167F in a plane including a central axis thereof is consistent over the entire circumference.

As shown in FIG. 10, in a state in which a leaf spring 371 of the partition member 133F is separated from the valve closing part 167F, the entirety of a chamber 402 communicates with a lower chamber 20 through a communication hole 403 of the end cap 365.

When the leaf spring 371 of the partition member 133F bends to the flat surface 368D side of the end cap 365, the leaf spring 371 comes into contact with the entire circumference of the valve closing part 167F. Then, the leaf spring 371 closes the communication hole 403. In this state, the chamber 402 forms a pressure chamber that is closed radially outward from the valve closing part 167F. The pressure chamber does not communicate with the lower chamber 20.

During an extension stroke, the leaf spring 371 of the partition member 133F receives a pressure of a back pressure chamber 363 to which a pressure of a pressurized upper chamber 19 is applied from a bypass passage 351 through an orifice 362A. During the extension stroke, the leaf spring 371 of the partition member 133F receives the pressure of the back pressure chamber 363 and causes a supported part 371A to be seated on a valve seat 368A of the end cap 365. At the same time, the partition member 133E elastically deforms an elastic bending part 371B of the leaf spring 371 toward the concave surface 368B of the end cap 365 to reduce a volume of the chamber 402 while increasing a volume of the back pressure chamber 363.

The partition member 133F is provided at a second passage 191E and partitions the second passage 191E between the back pressure chamber 363 and the chamber 402. At the same time, the partition member 133F is displaced by an oil fluid L that has flowed in due to movement of the piston 18E and discharges at least some of the oil fluid L in the second passage 191E into the lower chamber 20 in a cylinder 2.

In the shock absorber 1F, when a displacement of the leaf spring 371 of the partition member 133F is smaller than a predetermined amount during the extension stroke, the leaf spring 371 is separated from the valve closing part 167F provided in the end cap 365, and therefore, the oil fluid L flows from the entire chamber 402 to the lower chamber 20 through the communicating hole 403.

On the other hand, during the extension stroke, when the displacement of the leaf spring 371 of the partition member 133F is equal to or larger than the predetermined amount, the leaf spring 371 comes into contact with the entire circumference of the valve closing part 167F of the end cap 365 and forms the closed pressure chamber on a radially outward side with respect to the valve closing part 167F of the chamber 402. The pressure chamber does not communicate with the lower chamber 20.

That is, in the extension-side damping force adjustment mechanism 350F, the leaf spring 371 of the partition member 133F is displaced by the oil fluid L that has flowed into the back pressure chamber 363 due to movement of the piston 18E during the extension stroke, and discharges at least some of the oil fluid L in the chamber 402 constituting the second passage 191E into the lower chamber 20 in the cylinder 2. Also, in the extension-side damping force adjustment mechanism 350F, the valve closing part 167F forms the pressure chamber that is closed between the flat surface 368D in the second passage 191E of the end cap 365 and the leaf spring 371 of the partition member 133F, thereby restricting movement of the oil fluid L in the pressure chamber. The pressure chamber is formed when the leaf spring 371 and the valve closing part 167F in the second passage 191E of the end cap 365 come into contact with each other due to the displacement of the leaf spring 371 of the partition member 133F. The valve closing part 167F is provided on the flat surface 368D in the second passage 191E of the end cap 365, and is formed of an elastic member that deforms to come into contact with the leaf spring 371 after the displacement of the leaf spring 371 of the partition member 133F and allow the leaf spring 371 to be displaceable even after the contact. In the extension-side damping force adjustment mechanism 350F, the partition member 133F is provided in the second passage 191E. The partition member 133F partitions the second passage 191E between the back pressure chamber 363 and the chamber 402.

In the shock absorber 1F of the seventh embodiment, the extension-side damping force adjustment mechanism 350F provided at the second passage 191E to vary the damping force includes the valve closing part 167F that forms the pressure chamber closed between the flat surface 368D in the second passage 191E of the end cap 365 and the leaf spring 371 of the partition member 133F to restrict movement of the oil fluid L in the pressure chamber. In the shock absorber 1F, when the valve closing part 167F forms the pressure chamber closed between the inside of the second passage 191E and the leaf spring 371 of the partition member 133F, if a pressure of the back pressure chamber 363 on a side of the leaf spring 371 opposite to the pressure chamber in the second passage 191E increases, a pressure inside the pressure chamber also increases accordingly, thereby suppressing the displacement of the leaf spring 371. In this way, since the shock absorber 1F can suppress the displacement of the partition member 133F, durability of the partition member 133F can be enhanced. Also, since the shock absorber 1F suppresses the displacement of the partition member 133F by the pressure of the oil fluid L, it is possible to suppress occurrence of abnormal noise. Also, since the shock absorber 1F can gently suppress the displacement of the partition member 133F by the pressure of the oil fluid L, it is possible to suppress a decrease in ride comfort that occurs due to a sudden change in damping force.

Also, in the shock absorber 1F, the pressure chamber is formed when the leaf spring 371 and the valve closing part 167F provided in the end cap 365 come into contact with each other due to the displacement of the leaf spring 371 of the partition member 133F. In the shock absorber 1F, the pressure chamber is formed by the displacement of the leaf spring 371 of the partition member 133F as described above. Therefore, the shock absorber 1F, by using the displacement of the partition member 133F, can vary the damping force by easily displacing the partition member 133F without forming the pressure chamber, or can suppress the displacement of the partition member 133F by forming the pressure chamber.

Also, in the shock absorber 1F, the valve closing part 167F is provided on the flat surface 368D in the second passage 191E of the end cap 365, and is formed of an elastic member that deforms to come into contact with the leaf spring 371 after the displacement of the leaf spring 371 of the partition member 133F and allow the leaf spring 371 to be displaceable even after the contact. Therefore, the shock absorber 1F can more gently suppress the displacement of the partition member 133F at the time of suppressing the displacement.

### Eighth Embodiment

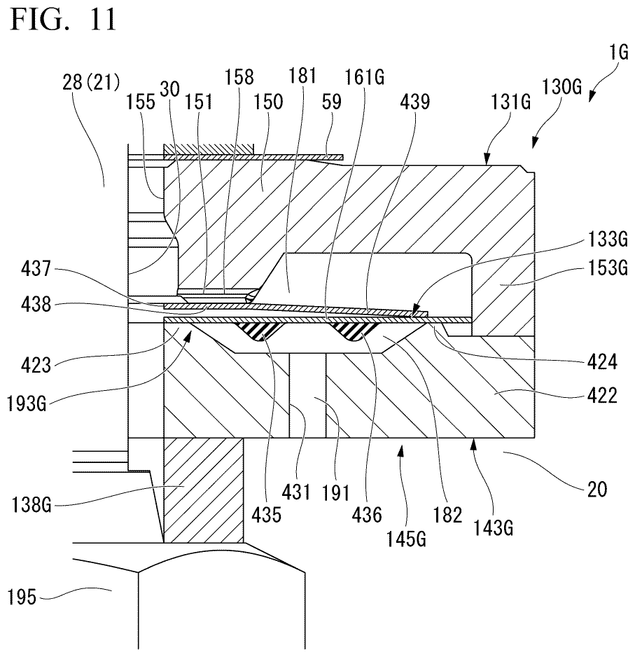

Next, an eighth embodiment will be described mainly on the basis of FIG. 11 focusing on differences from the first embodiment. Also, parts common to those in the first embodiment will be denoted by the same terms and the same reference signs.

As shown in FIG. 11, a shock absorber 1G of the eighth embodiment includes a frequency sensitive mechanism 130G (second damping force mechanism), which is partially different from the frequency sensitive mechanism 130, instead of the frequency sensitive mechanism 130.

The frequency sensitive mechanism 130G includes a valve case 145G, which is partially different from the valve case 145, instead of the valve case 145. The valve case 145G includes a case member 131G, which is partially different from the case member 131, instead of the case member 131. The case member 131G includes a cylindrical part 153G instead of the cylindrical part 153. The cylindrical part 153G has an axial length smaller than that of the cylindrical part 153.

The valve case 145G has a cover member 143G instead of the discs 132 and 135 to 137.

The cover member 143G is made of a metal and has a perforated disc shape. The cover member 143G is fitted onto a mounting shaft part 28 of a piston rod 21.

The cover member 143G has a base plate part 422, an inner seat part 423, and an outer seat part 424.

The base plate part 422 has a perforated disc shape. The base plate part 422 has a constant outer diameter over the entire circumference and a constant radial width over the entire circumference. The base plate part 422 of the cover member 143G is fitted onto the mounting shaft part 28 of the piston rod 21. A passage hole 431 penetrating the base plate part 422 in an axial direction is formed at an intermediate position of the base plate part 422 in the radial direction. A plurality of passage holes 431 are formed at regular intervals in a circumferential direction of the base plate part 422. The plurality of passage holes 431 are aligned in position from a central axis of the base plate part 422.

The inner seat part 423 has an annular shape. The inner seat part 423 protrudes to one side in an axial direction of the base plate part 422 from an inner circumferential edge portion of the base plate part 422.

The outer seat part 424 has an annular shape with a larger diameter than the inner seat part 423. The outer seat part 424 protrudes to the same side as the inner seat part 423 in the axial direction of the base plate part 422 from an intermediate position of the base plate part 422 in the radial direction.

A height position of a distal end of the outer seat part 424 in the axial direction of the base plate part 422 is equal to a height position of a distal end of the inner seat part 423. The plurality of passage holes 431 are formed in the base plate part 422 between the inner seat part 423 and the outer seat part 424 in the radial direction.

The valve case 145G is formed by abutting the case member 131G and the cover member 143G against each other. At that time, the case member 131G and the cover member 143G are directed such that a protruding part 151 faces the inner seat part 423 and the outer seat part 424. Then, a portion of the base plate part 422 of the cover member 143G that is radially outward of the outer seat part 424 abuts against the cylindrical part 153G of the case member 131G.

The frequency sensitive mechanism 130G includes a partition member 133G, which is different from the partition member 133, instead of the partition member 133. The partition member 133G has a valve disc 161G, an inner valve closing part 435 (valve closing part), and an outer valve closing part 436 (valve closing part).

The valve disc 161G is made of a metal. The valve disc 161G has a perforated circular flat plate shape with a constant thickness. The valve disc 161G has a constant outer diameter over the entire circumference and a constant radial width over the entire circumference. The mounting shaft part 28 of the piston rod 21 is inserted through an inner circumference of the valve disc 161G. The valve disc 161G is elastically deformable, that is, bendable. The valve disc 161G has an outer diameter slightly smaller than an inner diameter of the cylindrical part 153G. The valve disc 161G is positioned in the radial direction with respect to the case member 131G at an inner circumferential portion of the cylindrical part 153G. The valve disc 161G is guided by the inner circumferential portion of the cylindrical part 153G and moves in an axial direction of the case member 131G.

The inner valve closing part 435 is made of an elastic seal material. The inner valve closing part 435 is made of rubber and has an annular shape. The inner valve closing part 435 is coaxial with the valve disc 161G and is adhered to a surface of the valve disc 161G on one axial side by baking. An inner circumferential portion of the inner valve closing part 435 has an inner diameter that increases with distance away from the valve disc 161G in an axial direction of the valve disc 161G. An outer circumferential portion of the inner valve closing part 435 has an outer diameter that decreases with distance away from the valve disc 161G in the axial direction of the valve disc 161G. Therefore, a cross-sectional shape of the inner valve closing part 435 in a plane including the central axis of the valve disc 161G is a tapered single-chevron shape that becomes thinner with distance away from the valve disc 161G in the axial direction of the valve disc 161G. A cross-sectional shape of the inner valve closing part 435 in a plane including a central axis thereof is consistent over the entire circumference.

The outer valve closing part 436G is made of an elastic seal material. The outer valve closing part 436 is made of rubber and has an annular shape with a larger diameter than the inner valve closing part 435. The outer valve closing part 436 is coaxial with the valve disc 161G and is adhered to a surface of the valve disc 161G on the same side as the inner valve closing part 435 in the axial direction by baking. An inner circumferential portion of the outer valve closing part 436 has an inner diameter that increases with distance away from the valve disc 161G in an axial direction of the valve disc 161G. An outer circumferential portion of the outer valve closing part 436 has an outer diameter that decreases with distance away from the valve disc 161G in the axial direction of the valve disc 161G. Therefore, a cross-sectional shape of the outer valve closing part 436 in a plane including the central axis of the valve disc 161G is a tapered single-chevron shape that becomes thinner with distance away from the valve disc 161G in the axial direction of the valve disc 161G. A cross-sectional shape of the outer valve closing part 436 in a plane including a central axis thereof is consistent over the entire circumference. The inner valve closing part 435 and the outer valve closing part 436 have the same protrusion height from the valve disc 161G.

The partition member 133G is disposed inside the valve case 145G in a direction such that the inner valve closing part 435 and the outer valve closing part 436 protrude to the cover member 143G side from the valve disc 161G in an axial direction of the valve case 145G. Then, the inner valve closing part 435 is disposed on an outer side of the inner seat part 423 and on an inner side of the passage hole 431 in a radial direction of the cover member 143G. Also, the outer valve closing part 436 is disposed on an inner side of the outer seat part 424 and on an outer side of the passage hole 431 in the radial direction of the cover member 143G.

The frequency sensitive mechanism 130G includes a spring member 437. The spring member 437 is made of a metal and has a base plate part 438 and a spring plate part 439. The base plate part 438 has a perforated flat disc shape. A plurality of, specifically five, spring plate parts 439 are provided at regular intervals in a circumferential direction of the base plate part 438. The spring plate parts 439 each extend outward in a radial direction of the base plate part 438 from the base plate part 438. The spring plate part 439 is inclined with respect to the base plate part 438 such that it becomes further away from the base plate part 438 in an axial direction of the base plate part 438 as it is positioned farther outward in the radial direction of the base plate part 438. The base plate part 438 of the spring member 437 is fitted onto the mounting shaft part 28 of the piston rod 21.

The spring member 437 is provided between the protruding part 151 and the partition member 133G. In the spring member 437, the base plate part 438 is in contact with the protruding part 151, and the spring plate part 439 is in contact with the valve disc 161G of the partition member 133G. Thereby, the spring member 437 presses the valve disc 161G against the inner seat part 423 and the outer seat part 424.

In the partition member 133G, a portion of the valve disc 161G radially inward of the inner valve closing part 435 comes into contact with the inner seat part 423, and a portion of the valve disc 161G radially outward of the outer valve closing part 436 comes into contact with the outer seat part 424. In this state, the partition member 133G closes the passage hole 431. Also, the partition member 133G opens the passage hole 431 when the valve disc 161G is separated from the inner seat part 423 and the outer seat part 424 against a biasing force of the spring member 437. The valve disc 161G, the inner seat part 423, the outer seat part 424, and the spring member 437 constitute a check valve 193G.

The shock absorber 1G includes an annular member 138G, which has a smaller outer diameter than the annular member 138, instead of the annular member 138.

The partition member 133G is provided inside the valve case 145G and partitions the inside of the valve case 145G into a first chamber 181 and a second chamber 182. The first chamber 181 is provided between a bottom part 150 and the partition member 133G in the axial direction of the valve case 145G. The second chamber 182 is provided between the partition member 133G and the cover member 143G in the axial direction of the valve case 145G.

As shown in FIG. 11, in a state in which the inner valve closing part 435 and the outer valve closing part 436 of the partition member 133G are separated from the base plate part 422 of the cover member 143G, the entire second chamber 182 communicates with a lower chamber 20 through the passage hole 431 which is in the base plate part 422 of the cover member 143G.

When the partition member 133G deforms into a tapered shape, and thereby the inner valve closing part 435 and the outer valve closing part 436 are in contact with the base plate part 422 of the cover member 143G over the entire circumference, the second chamber 182 is partitioned into an inner pressure chamber on a radially inner side of the inner valve closing part 435, an outer pressure chamber on a radially outer side of the outer valve closing part 436, and a communication chamber positioned between the inner valve closing part 435 and the outer valve closing part 436 in the radial direction. The communication chamber communicates with the lower chamber 20 through the passage hole 431. Both the inner pressure chamber and the outer pressure chamber do not communicate with the communication chamber, and therefore, they do not communicate with the lower chamber 20.

During an extension stroke, an oil fluid L from an upper chamber 19 (see FIG. 2) is introduced into the first chamber 181 via a first passage 43 (see FIG. 2), a passage in a notch 81 (see FIG. 2) of a disc 50 (see FIG. 2), a passage in a groove part 30 of the piston rod 21 shown in FIG. 11, and a passage between the protruding part 151 of the case member 131G and the partition member 133G. Then, using contact points with the inner seat part 423 and the outer seat part 424 of the cover member 143G as fulcrums, the valve disc 161 of the partition member 133G bends such that a portion between the contact points is recessed to the base plate part 422 side.

With such a displacement, the partition member 133G increases a volume of the first chamber 181. Here, during this displacement of the partition member 133G, a volume of the second chamber 182 decreases. At that time, the oil fluid L in the second chamber 182 flows into the lower chamber 20 through the passage hole 431.

Here, during the extension stroke, when the displacement of the partition member 133G is smaller than a predetermined amount, the inner valve closing part 435 and the outer valve closing part 436 are separated from the base plate part 422 of the cover member 143G, and therefore, the oil fluid L flows from the entire second chamber 182 to the lower chamber 20 through the passage hole 431.

On the other hand, during the extension stroke, when the displacement of the partition member 133G is equal to or larger than the predetermined amount, both the inner valve closing part 435 and the outer valve closing part 436 come into contact with the base plate part 422 of the cover member 143G over the entire circumference, and partitions the second chamber 182 into the inner pressure chamber on a radially inner side of the inner valve closing part 435, the outer pressure chamber on a radially outer side of the outer valve closing part 436, and the communication chamber positioned between the inner valve closing part 435 and the outer valve closing part 436 in the radial direction. Therefore, the second chamber 182 is placed in a state in which the communication chamber communicates with the lower chamber 20 through the passage hole 431, but both the inner pressure chamber and the outer pressure chamber do not communicate with the lower chamber 20.

That is, in the frequency sensitive mechanism 130G, the partition member 133G is displaced by the oil fluid L that has flowed into the first chamber 181 due to movement of a piston 18 (see FIG. 2) during the extension stroke, and discharges at least some of the oil fluid L in the second chamber 182 constituting a part of a second passage 191 into the lower chamber 20 in a cylinder 2 (see FIG. 2). Also, in the frequency sensitive mechanism 130G, the inner valve closing part 435 and the outer valve closing part 436 form the inner pressure chamber and the outer pressure chamber that are closed between the cover member 143G in the second passage 191 and the partition member 133G, thereby restricting movement of the oil fluid L in the inner pressure chamber and the outer pressure chamber. The inner pressure chamber and the outer pressure chamber are formed when the inner valve closing part 435 and the outer valve closing part 436 come into contact with the cover member 143G in the second passage 191 due to the displacement of the partition member 133G. The inner valve closing part 435 and the outer valve closing part 436 are provided in the partition member 133G, and are formed of an elastic member that deforms to come into contact with the cover member 143G of the second passage 191 after the displacement of the partition member 133G and allow the partition member 133G to be displaceable even after the contact. In the frequency sensitive mechanism 130G, the partition member 133G is provided at the second passage 191. The partition member 133G partitions the second passage 191 between the first chamber 181 and the second chamber 182.

The shock absorber 1G varies the damping force according to a piston frequency similarly to the shock absorber 1.

In the shock absorber 1G of the eighth embodiment, the frequency sensitive mechanism 130G provided at the second passage 191 to vary the damping force includes the inner valve closing part 435 and the outer valve closing part 436 that form the inner pressure chamber and the outer pressure chamber closed between the cover member 143G in the second passage 191 and the partition member 133G to restrict movement of the oil fluid L in the inner pressure chamber and the outer pressure chamber. In the shock absorber 1G, when the inner valve closing part 435 and the outer valve closing part 436 form the inner pressure chamber and the outer pressure chamber closed between the inside of the second passage 191 and the partition member 133G, if a pressure of the first chamber 181 on a side of the partition member 133G opposite to the inner pressure chamber and the outer pressure chamber in the second passage 191 increases, pressures inside the inner pressure chamber and the outer pressure chamber also increase accordingly, thereby suppressing the displacement of the partition member 133G. In this way, since the shock absorber 1G can suppress the displacement of the partition member 133G, durability of the partition member 133G can be enhanced. Also, since the shock absorber 1G suppresses the displacement of the partition member 133G by the pressure of the oil fluid L, it is possible to suppress occurrence of abnormal noise. Also, since the shock absorber 1G can gently suppress the displacement of the partition member 133G by the pressure of the oil fluid L, it is possible to suppress a decrease in ride comfort that occurs due to a sudden change in damping force.

Also, in the shock absorber 1G, the inner pressure chamber and the outer pressure chamber are formed when the cover member 143G in the second passage 191 comes into contact with the inner valve closing part 435 and the outer valve closing part 436 due to the displacement of the partition member 133G. In the shock absorber 1G, the inner pressure chamber and the outer pressure chamber are formed by the displacement of the partition member 133G as described above. Therefore, the shock absorber 1G, by using the displacement of the partition member 133G, can vary the damping force by easily displacing the partition member 133G without forming the pressure chamber, or can suppress the displacement of the partition member 133G by forming the pressure chamber.

Also, in the shock absorber 1G, the inner valve closing part 435 and the outer valve closing part 436 are provided in the partition member 133G, and is formed of an elastic member that deforms to come into contact with the cover member 143G of the second passage 191 after the displacement of the partition member 133G and allow the partition member 133G to be displaceable even after the contact. Therefore, in the shock absorber 1G, the pressure chamber can be easily formed by the displacement of the partition member 133G, and the displacement of the partition member 133G can be more gently suppressed at the time of suppressing the displacement.

### Ninth Embodiment

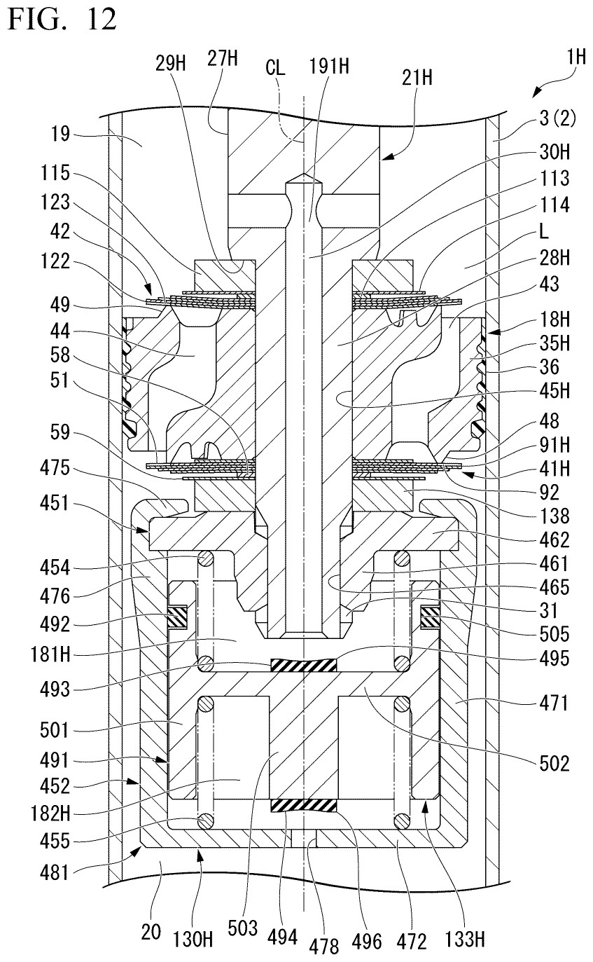

Next, a ninth embodiment will be described mainly on the basis of FIG. 12 focusing on differences from the first embodiment. Also, parts common to those in the first embodiment will be denoted by the same terms and the same reference signs.

As shown in FIG. 12, a shock absorber 1H includes a piston rod 21H, which is partially different from the piston rod 21, instead of the piston rod 21. The piston rod 21H does not include the groove part 30, and includes a rod internal passage 30H penetrating the inside and extending from an outer circumferential surface of a main shaft part 27H to an end portion of the mounting shaft part 28H on a side opposite to the main shaft part 27H in an axial direction. The main shaft part 27H differs from the main shaft part 27 in that a part of the rod internal passage 30H is formed therein and one end of the rod internal passage 30H opens to an outer circumferential surface thereof. The mounting shaft part 28H differs from the mounting shaft part 28 in that the groove part 30 is not formed, a part of the rod internal passage 30H is formed therein, and the other end of the rod internal passage 30H opens to an end surface on a side opposite to the main shaft part 27 in the axial direction. The rod internal passage 30H communicates with an upper chamber 19. The piston rod 21H is also inserted through a rod guide 22 (see FIG. 1) and a seal member 23 (see FIG. 1) and extends to the outside of the cylinder 2 at a side of the main shaft part 27H opposite to the mounting shaft part 28H in the axial direction.

The shock absorber 1H includes a piston 18H, which is partially different from the piston 18, instead of the piston 18. The piston 18H includes a piston main body 35H, which is partially different from the piston main body 35, instead of the piston main body 35. The piston main body 35H is integrally formed, and differs from the piston main body 35 in that an insertion hole 45H with a constant inner diameter is formed therein. The mounting shaft part 28H of the piston rod 21H is fitted into the insertion hole 45H of the piston main body 35H.

The shock absorber 1H does not include the discs 50, 53, and 56, the pilot disc 52, the pilot case 55, and the disc valve 99. In the shock absorber 1H, a plurality of discs 51 constitute a disc valve 91H. Then, discs 58 and 59 and an annular member 138 are provided in that order on a side of the disc valve 91H opposite to the piston 18H. The disc valve 91H constitutes an extension-side damping force mechanism 41H (first damping force mechanism). The damping force mechanism 41H differs from the damping force mechanism 41 in that it has the disc valve 91H, to which a back pressure is not applied, instead of the damping valve 91, and does not have a configuration for applying a back pressure.

Also, the shock absorber 1H includes a frequency sensitive mechanism 130H (second damping force mechanism), which is different from the frequency sensitive mechanism 130, instead of the frequency sensitive mechanism 130, and the nut 195.

The frequency sensitive mechanism 130H includes a cover member 451, a housing main body 452, a partition member 133H, a first spring 454, and a second spring 455.

The cover member 451 is made of a metal, and has a cover cylindrical part 461 and a cover base plate part 462.

The cover cylindrical part 461 has a cylindrical shape. The cover base plate part 462 has a disc shape and extends radially outward from one end portion of the cover cylindrical part 461 in the axial direction. A female thread 465 is formed on an inner circumferential portion of the cover cylindrical part 461. The cover member 451 is screwed onto a screw part 31 of the piston rod 21H at the female thread 465. The cover member 451 serves as a nut and clamps at least an inner circumferential side of components from an annular member 115 to the annular member 138. That is, the cover member 451 also serves as a nut.

The housing main body 452 is made of a metal and has a substantially bottomed cylindrical shape. The cover member 451 is attached to the housing main body 452 to close one end opening side of the housing main body 452. The housing main body 452 has a main body cylindrical part 471 and a main body bottom part 472.

The main body cylindrical part 471 has a cylindrical shape. An end portion of the main body cylindrical part 471 on a side opposite to the main body bottom part 472 is a thin wall portion 475, and a portion thereof excluding the thin wall portion 475 is a thick wall portion 476 that is thicker than the thin wall portion 475. Before the cover member 451 is assembled, the thin wall portion 475 extends along an axial extension of the thick wall portion 476. In this state, the thick wall portion 476 has an outer diameter substantially equal to that of the thin wall portion 475, and an inner diameter smaller than that of the thin wall portion 475.

The main body bottom part 472 has a disc shape and closes one end portion of the main body cylindrical part 471 in the axial direction. A passage hole 478 penetrating in the axial direction is formed in the main body bottom part 472 at a center in the radial direction.

The cover member 451, with the cover cylindrical part 461 as the front, is fitted into the housing main body 452 inside the thin wall portion 475 which extends along an axial extension of the thick wall portion 476. Thereafter, the housing main body 452 is bent radially inward as shown in FIG. 12 by swaging the thin wall portion 475. Thereby, the housing main body 452 and the cover member 451 are integrated to form a housing 481.

The partition member 133H is a free piston that is inserted into the housing 481 to be slidable. The partition member 133H has a partition member main body 491, a seal member 492, a first valve closing part 493 (valve closing part), and a second valve closing part 494 (valve closing part).

The partition member main body 491 is made of a metal, and has a piston cylindrical part 501, a piston closing plate part 502, and a piston extension part 503.

The piston cylindrical part 501 has a cylindrical shape. An annular seal retaining groove 505 recessed radially inward is formed at an outer circumferential portion on one end side of the piston cylindrical part 501 in the axial direction.

The piston closing plate part 502 has a disc shape and closes a central position of the piston cylindrical part 501 in the axial direction.

The piston extension part 503 has a columnar shape and extends from a center position of the piston closing plate part 502 in the radial direction to one side of the piston closing plate part 502 in the axial direction. The piston extension part 503 extends from the piston closing plate part 502 to a side of the piston closing plate part 502 opposite to the seal retaining groove 505 in the axial direction. The piston extension part 503 is provided coaxially with the piston cylindrical part 501 on a radially inner side of the piston cylindrical part 501.

The partition member main body 491 is slidably fitted into the main body cylindrical part 471 of the housing main body 452 at the piston cylindrical part 501. At that time, the partition member main body 491 is directed such that the piston extension part 503 extends from the piston closing plate part 502 to the main body bottom part 472 side in the axial direction of the piston closing plate part 502.

The seal member 492 has an annular shape, and is fitted and held in the seal retaining groove 505 of the partition member main body 491. The seal member 492 seals a gap between the piston cylindrical part 501 of the partition member main body 491 and the main body cylindrical part 471 of the housing 481. A cross section of the seal member 492 in a plane including a central axis thereof is an angular ring having a quadrangular shape.

The first valve closing part 493 is provided on a surface of the piston closing plate part 502 opposite to the piston extension part 503 in the axial direction. The first valve closing part 493 is provided at a center position of the piston closing plate part 502 in the radial direction. The first valve closing part 493 is made of rubber and has a disc shape. The first valve closing part 493 is adhered to the piston closing plate part 502 by baking. The first valve closing part 493 has an annular closing part 495 that protrudes in the axial direction further than the inside at an outer circumferential edge portion. A cross-sectional shape of the first valve closing part 493 in a plane including a central axis thereof is consistent over the entire circumference.

The second valve closing part 494 is provided on an end surface of the piston extension part 503 opposite to the piston closing plate part 502 in the axial direction. The second valve closing part 494 is made of rubber and has a disc shape. The second valve closing part 494 is adhered to the piston extension part 503 by baking. The second valve closing part 494 has an annular closing part 496 that protrudes in the axial direction further than the inside at an outer circumferential edge portion. A cross-sectional shape of the second valve closing part 494 in a plane including a central axis thereof is consistent over the entire circumference.

The first spring 454 has a coil shape and is interposed between the piston closing plate part 502 of the partition member 133H and the cover base plate part 462 of the housing 481. The first spring 454 is compressively deformed when the partition member 133H moves to the cover base plate part 462 side inside the housing 481. That is, the first spring 454 serves as a resistance element that is compressively deformed when the partition member 133H moves to the cover base plate part 462 side, and generates resistance against a displacement of the partition member 133H.

The second spring 455 has a coil shape and is interposed between the piston closing plate part 502 of the partition member 133H and the main body bottom part 472 of the housing 481. The second spring 455 is compressively deformed when the partition member 133H moves to the main body bottom part 472 side inside the housing 481. That is, the second spring 455 serves as a resistance element that is compressively deformed when the partition member 133H moves to the main body bottom part 472 side, and generates resistance against the displacement of the partition member 133H.

The first spring 454 and the second spring 455 bias the partition member 133H to be held at a neutral position inside the housing 481.

The partition member 133H is provided in the housing 481 and partitions the inside of the housing 481 into a first chamber 181H and a second chamber 182H.

The first chamber 181H is provided between the cover member 451 and the partition member 133H in an axial direction of the housing 481. The first chamber 181H can communicate with the upper chamber 19 through the rod internal passage 30H. The first chamber 181H is variable in capacity, and the capacity changes due to a displacement caused by movement of the partition member 133H.

The second chamber 182H is provided between the main body bottom part 472 of the housing main body 452 and the partition member 133H in the axial direction of the housing 481. The second chamber 182H can communicate with a lower chamber 20 through a passage inside the passage hole 478 of the main body bottom part 472. The second chamber 182H is variable in capacity, and the capacity changes due to a displacement caused by movement of the partition member 133H.

The rod internal passage 30H, the first chamber 181H, the second chamber 182H, and the passage inside the passage hole 478 constitute a second passage 191H. The second passage 191H is formed in parallel with first passages 43 and 44. The second passage 191H is provided so that an oil fluid L can flow in from the upper chamber 19 and the lower chamber 20 due to movement of the piston 18H. The passage hole 478 also has a function of an introduction orifice, and a variable width of a frequency sensitivity of the frequency sensitive mechanism 130H can be adjusted by using the passage hole 478 as an introduction orifice and changing a size of the passage hole 478.

As shown in FIG. 12, in a state in which the second valve closing part 494 of the partition member 133H is separated from the main body bottom part 472 of the housing main body 452, the entire second chamber 182H communicates with the lower chamber 20 through the passage in the passage hole 478.

As shown in FIG. 12, in a state in which the first valve closing part 493 of the partition member 133H is separated from the piston rod 21H, the entire first chamber 181H communicates with the upper chamber 19 through the rod internal passage 30H.

In a state in which the second valve closing part 494 of the partition member 133H is in contact with the main body bottom part 472 of the housing main body 452 over the entire circumference at the closing part 496, the second valve closing part 494 closes an end portion of the passage in the passage hole 478 of the main body bottom part 472 on the second chamber 182H side. In this state, the second chamber 182H forms a closed second pressure chamber on a radially outward side with respect to the second valve closing part 494. The second pressure chamber does not communicate with the lower chamber 20.

When the first valve closing part 493 of the partition member 133H is in contact with the piston rod 21H over the entire circumference at the closing part 495, the first valve closing part 493 closes an end portion of the rod internal passage 30H on the first chamber 181H side. In this state, the first chamber 181H forms a closed first pressure chamber on a radially outward side with respect to the first valve closing part 493. The first pressure chamber does not communicate with the upper chamber 19.

During an extension stroke, the oil fluid L from the upper chamber 19 is introduced into the first chamber 181H through the rod internal passage 30H of the piston rod 21H. Then, the partition member 133H moves toward the main body bottom part 472 inside the housing 481. At that time, the partition member 133H compressively deforms the second spring 455 interposed between itself and the main body bottom part 472 in the axial direction of the housing 481.

Due to the displacement as described above, the partition member 133H increases a volume of the first chamber 181H. Here, during this displacement of the partition member 133H, a volume of the second chamber 182H decreases. At that time, the oil fluid L in the second chamber 182H flows into the lower chamber 20 through the passage in the passage hole 478.

Here, during the extension stroke, when the displacement of the partition member 133H is smaller than a predetermined amount, the second valve closing part 494 is separated from the main body bottom part 472 of the housing 481, and therefore, the oil fluid L flows from the entire second chamber 182H to the lower chamber 20 through the passage in the passage hole 478.

On the other hand, during the extension stroke, when the displacement of the partition member 133H is equal to or larger than the predetermined amount, the second valve closing part 494 comes into contact with the main body bottom part 472 of the housing 481 over the entire circumference at the closing part 496, and forms the second pressure chamber closed on a radially outer side of the second valve closing part 494 in the second chamber 182H. This second pressure chamber does not communicate with the lower chamber 20.

That is, in the frequency sensitive mechanism 130H, the partition member 133H is displaced by the oil fluid L that has flowed into the first chamber 181H due to movement of the piston 18H during the extension stroke, and discharges at least some of the oil fluid L in the second chamber 182H constituting the second passage 191H into the lower chamber 20 in the cylinder 2. Also, in the frequency sensitive mechanism 130H, the second valve closing part 494 forms the closed second pressure chamber between the main body bottom part 472 in the second passage 191H of the housing 481 and the partition member 133H, thereby restricting movement of the oil fluid L in the second pressure chamber. The second pressure chamber is formed when the second valve closing part 494 and the main body bottom part 472 in the second passage 191H come into contact with each other due to the displacement of the partition member 133H. The second valve closing part 494 is provided in the partition member 133H, and is formed of an elastic member that deforms to come into contact with the main body bottom part 472 of the second passage 191H after the displacement of the partition member 133H and allow the partition member 133H to be displaceable even after the contact. In the frequency sensitive mechanism 130H, the partition member 133H is provided at the second passage 191H. The partition member 133H partitions the second passage 191H between the first chamber 181H and the second chamber 182H.

The shock absorber 1H varies the damping force according to a piston frequency during the extension stroke similarly to the shock absorber 1.

During a compression stroke, the oil fluid L from the lower chamber 20 is introduced into the second chamber 182H through the passage in the passage hole 478 of the housing 481. Then, the partition member 133H moves toward the cover base plate part 462 of the cover member 451 inside the housing 481. At that time, the partition member 133H compressively deforms the first spring 454 interposed between itself and the cover base plate part 462 in the axial direction of the housing 481.

Due to the displacement as described above, the partition member 133H increases a volume of the second chamber 182H. Here, during this displacement of the partition member 133H, a volume of the first chamber 181H decreases. At that time, the oil fluid L in the first chamber 181H flows into the upper chamber 19 through the rod internal passage 30H.

Here, during the compression stroke, when a displacement of the partition member 133H is smaller than a predetermined amount, the first valve closing part 493 is separated from the piston rod 21H, and therefore, the oil fluid L flows from the entire first chamber 181H to the upper chamber 19 through the rod internal passage 30H.

On the other hand, during the compression stroke, when the displacement of the partition member 133H is equal to or larger than the predetermined amount, the first valve closing part 493 comes into contact with the piston rod 21H over the entire circumference at the closing part 495, and forms the first pressure chamber closed on a radially outer side of the first valve closing part 493 in the first chamber 181H. This first pressure chamber does not communicate with the upper chamber 19.

That is, in the frequency sensitive mechanism 130H, the partition member 133H is displaced by the oil fluid L that has flowed into the second chamber 182H due to movement of the piston 18H during the compression stroke, and discharges at least some of the oil fluid L in the first chamber 181H into the upper chamber 19 in the cylinder 2. Also, in the frequency sensitive mechanism 130H, the first valve closing part 493 forms the closed first pressure chamber between the cover base plate part 462 in the second passage 191H of the housing 481 and the partition member 133H, thereby restricting movement of the oil fluid L in the first pressure chamber. The first pressure chamber is formed when the first valve closing part 493 and the piston rod 21H in the second passage 191H come into contact with each other due to the displacement of the partition member 133H. The first valve closing part 493 is provided in the partition member 133H, and is formed of an elastic member that deforms to come into contact with the piston rod 21H in the second passage 191H after the displacement of the partition member 133H and allow the partition member 133H to be displaceable even after the contact.

The shock absorber 1H also varies the damping force according to a piston frequency during the compression stroke so that the damping force becomes softer at high frequencies and harder at low frequencies.

In the shock absorber 1H of the ninth embodiment, the frequency sensitive mechanism 130H provided at the second passage 191H to vary the damping force includes the second valve closing part 494 that forms the second pressure chamber closed between the main body bottom part 472 in the second passage 191H and the partition member 133H to restrict movement of the oil fluid L in the second pressure chamber. In the shock absorber 1H, when the second valve closing part 494 forms the second pressure chamber closed between the inside of the second passage 191H and the partition member 133H, if a pressure of the first chamber 181H of the second passage 191H on a side of the partition member 133H opposite to the second pressure chamber increases, a pressure inside the second pressure chamber also increases accordingly, thereby suppressing the displacement of the partition member 133H.

Also, in the shock absorber 1H, the frequency sensitive mechanism 130H includes the first valve closing part 493 that forms the first pressure chamber closed between the cover base plate part 462 in the second passage 191H and the partition member 133H to restrict the movement of the oil fluid L in the first pressure chamber. In the shock absorber 1H, when the first valve closing part 493 forms the first pressure chamber closed between the inside of the second passage 191H and the partition member 133H, if a pressure of the second chamber 182H of the second passage 191H on a side of the partition member 133H opposite to the first pressure chamber increases, a pressure inside the first pressure chamber also increases accordingly, thereby suppressing the displacement of the partition member 133H.

Since the shock absorber 1H can suppress the displacement of the partition member 133H during both the extension stroke and the compression stroke, durability of the partition member 133H can be enhanced. Also, since the shock absorber 1H suppresses the displacement of the partition member 133H by the pressure of the oil fluid L, it is possible to suppress occurrence of abnormal noise. Also, since the shock absorber 1H can gently suppress the displacement of the partition member 133H by the pressure of the oil fluid L, it is possible to suppress a decrease in ride comfort that occurs due to a sudden change in damping force.

Also, in the shock absorber 1H, the second pressure chamber is formed when the main body bottom part 472 in the second passage 191H and the second valve closing part 494 come into contact with each other due to the displacement of the partition member 133H. In the shock absorber 1H, the second pressure chamber is formed by the displacement of the partition member 133H as described above.

Also, in the shock absorber 1H, the first pressure chamber is formed when the piston rod 21H in the second passage 191H and the first valve closing part 493 come into contact with each other due to the displacement of the partition member 133H. In the shock absorber 1H, the first pressure chamber is formed by the displacement of the partition member 133H as described above.

Therefore, during both the extension stroke and the compression stroke, the shock absorber 1H, by using the displacement of the partition member 133H, can vary the damping force by easily displacing the partition member 133H without forming the first pressure chamber and the second pressure chamber, or can suppress the displacement of the partition member 133H by forming the first pressure chamber or the second pressure chamber.

Also, in the shock absorber 1H, the second valve closing part 494 is provided in the partition member 133H, and is formed of an elastic member that deforms to come into contact with the main body bottom part 472 of the second passage 191H after the displacement of the partition member 133H and allow the partition member 133H to be displaceable even after the contact.

Also in the shock absorber 1H, the first valve closing part 493 is provided in the partition member 133H, and is formed of an elastic member that deforms to come into contact with the piston rod 21H of the second passage 191H after the displacement of the partition member 133H and allow the partition member 133H to be displaceable even after the contact.

Therefore, in the shock absorber 1H, the first pressure chamber and the second pressure chamber can be easily formed by the displacement of the partition member 133H, and the displacement of the partition member 133G can be more gently suppressed at the time of suppressing the displacement during both the extension stroke and the compression stroke.

Further, a hydraulic shock absorber has been described as an example in the first to ninth embodiments, but the above-described structure can also be applied to a shock absorber that uses water or air as a working fluid.

### INDUSTRIAL APPLICABILITY

According to the shock absorber of each of the above aspects of the present invention, durability of the partition member can be enhanced. Therefore, industrial applicability is high.

### REFERENCE SIGNS LIST

1, 1C to 1H Shock absorber
2 Cylinder
18, 18H, 18E Piston
19 Upper chamber
20 Lower chamber
21, 21E, 21H Piston rod
41, 41E, 41H, 42, 42E Damping force mechanism (first damping force mechanism)
43, 43E, 44, 44E First passage
130, 130A to 130D, 130G, 130H Frequency sensitive mechanism (second damping force mechanism)
133, 133A to 133H Partition member
167, 167A to 167F Valve closing part
187 Pressure chamber
191, 191E, 191H Second passage
350, 350F Extension-side damping force adjustment mechanism (second damping force mechanism)
435 Inner valve closing part (valve closing part)
436 Outer valve closing part (valve closing part)
493 First valve closing part (valve closing part)
494 Second valve closing part (valve closing part)

1. A shock absorber comprising:
a cylinder in which a working fluid is sealed;
a piston fitted in the cylinder to be slidable and partitioning an inside of the cylinder into two chambers;
a piston rod connected to the piston and extending to an outside of the cylinder;
a first passage allowing communication between the two chambers so that the working fluid is able to flow due to movement of the piston;
a second passage formed in parallel with the first passage and provided to allow the working fluid of at least one of the two chambers to flow in due to movement of the piston;
a first damping force mechanism provided at the first passage and configured to generate a damping force; and
a second damping force mechanism
provided at the second passage,
including: a partition member which
is formed of a disc having a plate shape and an elastic member provided at an outer circumferential side of the disc, wherein inner circumferential side of the disc is supported by a support member on only one side without being clamped from both sides,
partitions the second passage,
is displaced by the working fluid that has flowed in due to movement of the piston, and
discharges at least some of the working fluid in the second passage into the cylinder; and
a valve closing part which forms a pressure chamber closed between an inside of the second passage and the partition member to restrict movement of the working fluid in the pressure chamber, and varying a damping force.

2. The shock absorber according to claim 1, wherein the pressure chamber is formed when the partition member or the inside of the second passage comes into contact with the valve closing part due to a displacement of the partition member.

3. The shock absorber according to claim 1, wherein the valve closing part is provided in the partition member and is formed of an elastic member which deforms to come into contact with the second passage after a displacement of the partition member and allow the partition member to be displaceable even after the contact.

4. The shock absorber according to claim 1, wherein the valve closing part is provided at a part of the second passage and is formed of an elastic member which deforms to come into contact with the partition member after a displacement of the partition member and allow the partition member to be displaceable even after the contact.
